(19) United States
(12) Patent Application Publication
(10) Pub. No.: US 2023/0361293 A1
(43) Pub. Date: Nov. 9, 2023

(54) PRE-AGED SODIUM NICKELATE CATHODE MATERIALS AND USES THEREOF

(71) Applicants: Energizer Brands, LLC, St. Louis, MO (US); Nanyang Technological University, Singapore (SG)

(72) Inventors: Deepika Ranganathan, Singapore (SG); Victor Siong, Singapore (SG); Yi Cai, Singapore (SG); Madhavi Srinivasan, Singapore (SG); Guanghong Zheng, Westlake, OH (US)

(21) Appl. No.: 18/301,544

(22) Filed: Apr. 17, 2023

Related U.S. Application Data
(60) Provisional application No. 63/363,064, filed on Apr. 15, 2022.

(51) Int. Cl. H01M 4/52; H01M 4/04; H01M 4/50; H01M 4/62; H01M 10/30

(52) U.S. Cl. CPC H01M 4/52; H01M 4/049; H01M 4/50; H01M 4/625; H01M 10/30; H01M 2004/028

(57) ABSTRACT

Provided herein are desodiated, pre-aged sodium nickelates, which have been desodiated via acid leaching, and pre-aged using a hydroxide solution. The desodiated, pre-aged sodium nickelates exhibit improved stability. Mixtures of such nickelates with EMD, and methods of making such sodium nickelates, along with alkaline electrochemical cells comprising such are also provided herein.

### CROSS REFERENCE TO RELATED APPLICATION

This application claims priority from U.S. provisional application Ser. No. 63/363,064, filed Apr. 15, 2022, which is hereby incorporated by reference in its entirety for all of its teachings.

### BACKGROUND

Alkaline electrochemical cells are commercially available in cell sizes commonly known as LR6 (AA), LR03 (AAA), LR14 (C) and LR20 (D). The cells have a cylindrical shape that must comply with the dimensional standards that are set by organizations such as the International Electrotechnical Commission. The electrochemical cells are utilized by consumers to power a wide range of electrical devices, for example, clocks, radios, toys, electronic games, film cameras generally including a flashbulb unit, as well as digital cameras. Such electrical devices possess a wide range of electrical discharge conditions, such as from low drain to relatively high drain.

As the shape and size of the batteries are often fixed, battery manufacturers must modify cell characteristics to provide increased performance. Attempts to address the problem of how to improve a battery's performance in a particular device, such as a digital camera, have usually involved changes to the cell's internal construction. For example, cell construction has been modified by increasing the quantity of active materials utilized within the cell.

High valent nickel materials including nickel oxyhydroxide (NiOOH), nickel dioxide (NiO₂), and various forms of nickel oxides, nickelates, and nickel oxyhydroxides are useful as cathode materials in alkaline systems due to their high capacity and cell voltage. Particularly, the delithiated LiNiO₂ such as LiₓNiO₂ (where x<<1) has an oxidation state higher than 3+ which potentially gives a much higher discharge capacity than EMD (MnO₂). However, nickelate LiₓNiO₂ is not chemically stable, and it degrades rapidly in high temperatures. Furthermore, these materials are thermodynamically unstable in aqueous electrolytes, resulting in the electrochemical reduction of the nickel cathode (loss of electrode capacity). Therefore, the shelf life of alkaline batteries with high valent nickel cathodes is limited compared to batteries containing some other cathode materials.

### SUMMARY OF THE INVENTION

An embodiment of the invention is a desodiated nickelate material, said cathode material having an X-ray diffraction (XRD) pattern comprising a first peak from about 11.9°-14° 2Θ, a second set of peaks from about 18°-22° 2Θ, a third peak from about 36.1°-38.6° 2Θ, a fourth peak from about 41°-44.2° 2Θ, a fifth peak from about 55.7°-58.9° 2Θ, a sixth peak from about 65°-67.3° 2Θ, and a seventh peak from about 69.5°-71.3° 2Θ. In an alternate embodiment, the desodiated nickelate material has an XRD pattern having at least 1, 2, 3, 4, 5, 6, or 7 of these seven peaks or sets of peaks. In an embodiment, the desodiated nickelate material has an XRD pattern having a peak from about 69.5°-71.3° 2Θ.

An embodiment is a desodiated nickelate material, said cathode material having an X-ray diffraction (XRD) pattern comprising a first peak from about 11.3°-14.6° 2Θ, a second set of peaks from about 17.3°-22.3° 2Θ, a third peak from about 23.8°-25.9° 2Θ, a fourth peak from about 27.2°-28.2° 2Θ, a fifth peak from about 36.2°-37.7° 2Θ, a sixth peak from about 40°-44° 2Θ, a seventh peak from about 55.7°-58.5° 2Θ, an eighth peak from about 65.2°-67.3° 2Θ, and a ninth peak from about 69.5°-71.1° 2Θ. In an alternate embodiment, the desodiated nickelate material has an XRD pattern having at least 1, 2, 3, 4, 5, 6, 7, 8, or 9 of these nine peaks or sets of peaks.

An embodiment is a pre-aged, desodiated nickelate material, said pre-aged, desodiated nickelate material having an X-ray diffraction (XRD) pattern comprising a first peak from about 11.9°-13.8° 2Θ, a second peak from about 17°-19.5° 2Θ, a third peak from about 24.7°-26.5° 2Θ, a fourth set of peaks from about 36.3°-39.2° 2Θ, a fifth set of peaks from about 41.9°-45.7° 2Θ, a sixth peak from 47.5°-49.5° 2Θ, a seventh peak from about 50.3°-52° 2Θ, an eighth peak from about 57.4°-58.7° 2Θ, and a ninth set of peaks from about 65°-68° 2Θ. In an alternate embodiment, the desodiated nickelate material has an XRD pattern having at least 1, 2, 3, 4, 5, 6, 7, 8, or 9 of these nine peaks or sets of peaks. In an embodiment, the desodiated nickelate material has an XRD pattern having a peak from about 50.3°-52° 2Θ.

An embodiment is a pre-aged, desodiated nickelate material, said pre-aged, desodiated nickelate material having an X-ray diffraction (XRD) pattern comprising a first peak from about 11.1°-14.4° 2Θ, a second set of peaks from about 17.2°-19.9° 2Θ, a third peak from about 24.1°-26.0° 2Θ, a fourth set of peaks from about 35.8°-39.3° 2Θ, a fifth set of peaks from about 43.4°-45.4° 2Θ, a sixth peak from 47.7°-49.4° 2Θ, a seventh peak from about 56.8°-59.6° 2Θ, an eighth peak from about 62.8°-64.5° 2Θ, a ninth peak from about 65°-67.4° 2Θ, and a tenth peak from about 68.1°-69.2° 2Θ. In an alternate embodiment, the desodiated nickelate material has an XRD pattern having at least 1, 2, 3, 4, 5, 6, 7, 8, 9, or 10 of these ten peaks or sets of peaks.

An embodiment is a method of producing a pre-aged, desodiated nickelate material, said method comprising:
i) contacting a sodium nickelate with an acid solution, so as to produce an acid-leached, desodiated nickelate; and
ii) contacting said acid-leached, desodiated nickelate with a pre-aging solution comprising a hydroxide, so as to produce the pre-aged, desodiated nickelate material.

An embodiment is a pre-aged, desodiated nickelate material made by any method described herein.

An embodiment is an alkaline cathode composition comprising any pre-aged, desodiated nickelate material described herein and electrolytic manganese dioxide (EMD).

An embodiment is an alkaline cathode composition comprising any pre-aged, desodiated nickelate material described herein, electrolytic manganese dioxide, graphite, and a binder.

An embodiment is a desodiated nickelate material comprising the following phases:
i) 15-50 wt % NiO₂;
ii) 20-60 wt % β-NiOOH;
iii) 0-25 wt % H_{0.61}NiO₂(H₂O)_{0.91}; and
iv) 0-25 wt % Na_{0.33}NiO₂(H₂O)_{0.54}.

An embodiment is a desodiated nickelate material having the formula NaₓNiO₂(H₂O)_{z}, where x=0.01-0.05 and z=0.2-1.1. In an embodiment, x is at least, at most, or about 0.01, 0.02, 0.03, 0.04, or 0.05, or within a range defined by any two of these values. In an embodiment, z is at least, at most, or about 0.2, 0.3, 0.4, 0.5, 0.6, 0.7, 0.8, 0.9, 1.0, or 1.1, or within a range defined by any two of these values.

An embodiment is a nickelate material comprising the following phases:
i) 4-62 wt % Na_{0.33}NiO₂(H₂O)_{0.54};
ii) 30-80 wt % (Li_{0.39}Ni_{0.01})(NiO₂) and/or (Li_{0.49}Ni_{0.01})(NiO₂) and/or (Li_{0.45}Ni_{0.05})(NiO₂); and
iii) 0-50 wt % β-NiOOH.

An embodiment is a nickelate material comprising the following phases:
i) 80-85 wt % Na_{0.33}NiO₂(H₂O)_{0.54}; and
ii) 15-20 wt % β-NiOOH.

An embodiment is a nickelate material having the formula NaₓLi_{y}NiO₂(H₂O)_{z}, where x=0.01-0.05, y=0.15-0.45 and z=0.1-0.8. In an embodiment, x is at least, at most, or about 0.01, 0.02, 0.03, 0.04, or 0.05, or within a range defined by any two of these values. In an embodiment, y is at least, at most, or about 0.15, 0.20, 0.25, 0.30, 0.35, 0.40, or 0.45, or within a range defined by any two of these values. In an embodiment, z is at least, at most, or about 0.1, 0.2, 0.3, 0.4, 0.5, 0.6, 0.7, or 0.8, or within a range defined by any two of these values.

An embodiment is a nickelate material which exhibits three discharge plateaus vs. Zn/ZnO reference electrode during discharge to 1.0 V voltage at 10 mA/g discharge rate.

An embodiment is a composition comprising particles of a nickelate material, wherein said particles comprise:
i) an interior core, comprising nickelate which has not been pre-aged with a hydroxide; and
ii) an exterior layer, comprising nickelate which has been pre-aged with a hydroxide.

An embodiment is an alkaline electrochemical cell comprising any nickelate material or composition described herein.

### BRIEF SUMMARY OF THE DRAWINGS

FIG. 1 is a cross-sectional elevation view of an alkaline electrochemical of an embodiment.

FIG. 2 shows the X-ray diffraction (XRD) pattern for Sodium Nickel Oxide.

FIG. 3 shows the X-ray diffraction (XRD) pattern for acid treated Sodium Nickel Oxide.

FIG. 4 shows the X-ray diffraction (XRD) pattern for acid treated NaNiO₂ powder aged in 40 wt % KOH/6 wt % ZnO for 24 h.

FIG. 5 shows the X-ray diffraction (XRD) pattern for LiOH pre-aged NaₓNiO₂.

FIG. 6 shows the X-ray diffraction (XRD) pattern for LiOH pre-aged NaₓNiO₂ after aging in 40 wt % KOH/6 wt % ZnO for 24 h.

FIG. 7 shows a specific capacity comparison of EMD, non-preaged and LiOH preaged nickelates at 1 V after half-cell aging at 60° C. for 0, 3, 7 and 14 days.

FIG. 8 shows the discharge curves of non-preaged and LiOH preaged nickelates before and after aging in 40 wt % KOH/6 wt % ZnO for 24 hours at 10 mA/g.

FIG. 9 shows a comparison of specific capacity at 1 V of EMD mixed 0.1 M LiOH/1 min preaged nickelate and non-preaged nickelate.

FIG. 10 shows a comparison of efficiency to 1 V of EMD mixed 0.1 M LiOH/1 min preaged nickelate and non-preaged nickelate.

FIG. 11 shows XRD patterns of synthesized non-preaged nickelates.

FIG. 12 shows XRD patterns of synthesized LiOH preaged nickelates.

FIG. 13 shows XRD patterns of alpha, beta, and sodium nickelates.

FIG. 14 shows Rietveld analysis of XRD pattern of non-preaged nickelate I (desodiated NaNiO₂) used for phase quantification.

FIG. 15 shows Rietveld analysis of XRD pattern of non-preaged nickelate II (desodiated NaNiO₂) for phase quantification.

FIG. 16 shows Rietveld analysis of XRD pattern of pre-aged nickelate I (0.1 M LiOH, 1 min) derived from non-preaged nickelate I for phase quantification.

FIG. 17 shows Rietveld analysis of XRD pattern of pre-aged nickelate II (0.1 M LiOH, 1 min) derived from non-preaged nickelate II for phase quantification.

FIG. 18 shows Rietveld analysis of XRD pattern of pre-aged nickelate (0.5 M LiOH, 10 mins, from Example 4) for phase quantification.

FIG. 19 shows Rietveld analysis of XRD pattern of pre-aged nickelate (0.1 M LiOH, 10 mins, from Example 4) for phase quantification.

FIG. 20 shows a comparison of discharge characteristics of α-nickelate, β-nickelate, desodiated NaNiO₂ before and after pre-aging in 0.1 M LiOH for 1 min, up to 1.5 V.

FIG. 21 shows a comparison of discharge characteristics of α-nickelate, β-nickelate, desodiated NaNiO₂ before and after pre-aging in 0.1 M LiOH for 1 min, up to 1.0 V, and a depiction of the three discharge regions, discussed in more detail below.

FIG. 22 shows a schematic of a representative sodium nickelate particle having an interior core which has not been pre-aged, and an exterior layer which has been pre-aged.

### DETAILED DESCRIPTION

Various embodiments now will be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements. Like numbers refer to like elements throughout. In the following description, various components may be identified as having specific values or parameters, however, these items are provided as exemplary embodiments. Indeed, the exemplary embodiments do not limit the various aspects and concepts of the embodiments as many comparable parameters, sizes, ranges, and/or values may be implemented. The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item.

It was in an effort to overcome limitations of existing electrochemical cells that the present embodiments were designed. Typically, NaₓNiO₂ resulting from acid leached NaNiO₂ has a lower capacity than acid delithiated LiₓNiO₂ and a poorer stability than beta-nickelate. A preaging process is disclosed which results in a sodium nickelate material with improved chemical stability at high temperatures.

Each embodiment disclosed herein is contemplated as being applicable to each of the other disclosed embodiments. All combinations and sub-combinations of the various elements described herein are within the scope of the embodiments.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 5.1%-9.9%, and 5.01%-9.99%.

As used herein, “about” in the context of a numerical value or range means within ±10%, ±5%, or ±1% of the numerical value or range recited or claimed.

As used herein, “nickelate” refers to a salt containing an anion which contains nickel, or a compound comprising nickel bound to oxygen and at least one other element.

As used herein, “nickel compound” refers to any compound comprising nickel. “Nickel material” refers to any material comprising nickel.

As used herein, “sodium nickelate material” or “sodium nickelate compound” refers to any nickelate comprising sodium. Non-limiting examples include NaₓNiO₂, wherein 0<x≤1.

As used herein, “desodiated nickelate” refers to the nickel compound obtained when a sodium-containing nickel compound has some or all of its sodium removed.

As used herein, “oxide” refers to a chemical compound that contains at least one oxygen atom and one other element. As used herein, “nickel oxide” refers to any nickel-containing oxide. Nickel oxides may comprise other cations and anions. Non-limiting examples include nickel dioxide (NiO₂), nickel hydroxide (Ni(OH)₂), and hydrated alkali nickel oxide such as NaₓNiO₂·n(H₂O).

As used herein, “oxyhydroxide” refers to a chemical compound or complex containing an oxide group and a hydroxide group. As used herein, “nickel oxyhydroxide” refers to any nickel-containing oxyhydroxide. Nickel oxyhydroxides may comprise other cations and anions. A non-limiting example is nickel oxyhydroxide (NiOOH).

As used herein, “sodium compound” refers to any compound comprising sodium. In an embodiment, the sodium compound comprises both sodium and oxygen. Non-limiting examples include NaOH (sodium hydroxide), Na₂O (sodium oxide), Na₂O₂ (sodium peroxide), and NaₓNiO₂ (sodium nickel oxide) where 0<x≤1.

As used herein, “improvement” with respect to storage stability means that the storage stability (i.e. “shelf-life”) is increased. Generally, an “improvement” of a property or metric of performance of a material or electrochemical cell means that the property or metric of performance differs (compared to that of a different material or electrochemical cell) in a manner that a user or manufacturer of the material or cell would find desirable (i.e. costs less, lasts longer, provides more power, more durable, easier or faster to manufacture, etc.).

As used herein, an “alkali metal” is an element from Group IA of the periodic table. Non-limiting examples include Li, Na, K, Rb, and Cs.

As used herein, an “alkaline earth metal” is an element from Group IIA of the periodic table.

Non-limiting examples include Mg, Ca, and Sr.

As used herein, a “transition metal” is an element from Groups IB-VIIIB of the periodic table. Non-limiting examples include Co, Mn, Zn, Y, Nb, and Ti.

As used herein, “other metals” or “another metal” includes all metals on the periodic table not included in the previously mentioned Groups, including Al, Ga, In, Sn, Tl, Pb, and Bi.

As used herein, a “primary” electrochemical cell is a non-rechargeable (i.e., disposable) electrochemical cell. A “secondary” electrochemical cell is a rechargeable electrochemical cell.

As used herein, “conductivity” refers to a given material's ability to conduct electric current. This is typically measured in Siemens per meter (S/m).

As used here, the term “pre-aging” or “pre-aged” refers to a controlled process to convert the material to a more stable resulting phase or a mixture of different phases over time when utilized in a final product. For example, a cathode material may be pre-aged using processes as discussed herein to provide a more shelf-stable cathode material when included within a battery. In certain embodiments, nickelate oxide is pre-aged by exposing the material to LiOH, NaOH, KOH, and/or other oxides or hydroxides of a specific concentration, at a specific temperature and a specified time period. The other hypothesis is that pre-aging could also form a protective film on the surface of the high oxidation state of nickel particles to slow down the decomposition reactions from high to low nickel oxidation state.

An embodiment is a desodiated nickelate material, said cathode material having an X-ray diffraction (XRD) pattern comprising a first peak from about 11.9°-14° 2Θ, a second set of peaks from about 18°-22° 2Θ, a third peak from about 36.1°-38.6° 2Θ, a fourth peak from about 41°-44.2° 2Θ, a fifth peak from about 55.7°-58.9° 2Θ, a sixth peak from about 65°-67.3° 2Θ, and a seventh peak from about 69.5°-71.3° 2Θ. In an alternate embodiment, the desodiated nickelate material has an XRD pattern having at least 1, 2, 3, 4, 5, 6, or 7 of these seven peaks or sets of peaks. In an embodiment, the desodiated nickelate material has an XRD pattern having a peak from about 69.5°-71.3° 2Θ.

An embodiment is a desodiated nickelate material, said cathode material having an X-ray diffraction (XRD) pattern comprising a first peak from about 11.3°-14.6° 2Θ, a second set of peaks from about 17.3°-22.3° 2Θ, a third peak from about 23.8°-25.9° 2Θ, a fourth peak from about 27.2°-28.2° 2Θ, a fifth peak from about 36.2°-37.7° 2Θ, a sixth peak from about 40°-44° 2Θ, a seventh peak from about 55.7°-58.5° 2Θ, an eighth peak from about 65.2°-67.3° 2Θ, and a ninth peak from about 69.5°-71.1° 2Θ. In an alternate embodiment, the desodiated nickelate material has an XRD pattern having at least 1, 2, 3, 4, 5, 6, 7, 8, or 9 of these nine peaks or sets of peaks.

In an embodiment, said nickelate material has been desodiated via an acid leaching method.

An embodiment is a pre-aged, desodiated nickelate material, said pre-aged, desodiated nickelate material having an X-ray diffraction (XRD) pattern comprising a first peak from about 11.9°-13.8° 2Θ, a second peak from about 17°-19.5° 2Θ, a third peak from about 24.7°-26.5° 2Θ, a fourth set of peaks from about 36.3°-39.2° 2Θ, a fifth set of peaks from about 41.9°-45.7° 2Θ, a sixth peak from 47.5°-49.5° 2Θ, a seventh peak from about 50.3°-52° 2Θ, an eighth peak from about 57.4°-58.7° 2Θ, and a ninth set of peaks from about 65°-68° 2Θ. In an alternate embodiment, the desodiated nickelate material has an XRD pattern having at least 1, 2, 3, 4, 5, 6, 7, 8, or 9 of these nine peaks or sets of peaks. In an embodiment, the desodiated nickelate material has an XRD pattern having a peak from about 50.3°-52° 2Θ.

An embodiment is a pre-aged, desodiated nickelate material, said pre-aged, desodiated nickelate material having an X-ray diffraction (XRD) pattern comprising a first peak from about 11.1°-14.4° 2Θ, a second set of peaks from about 17.2°-19.9° 2Θ, a third peak from about 24.1°-26.0° 2Θ, a fourth set of peaks from about 35.8°-39.3° 2Θ, a fifth set of peaks from about 43.4°-45.4° 2Θ, a sixth peak from 47.7°-49.4° 2Θ, a seventh peak from about 56.8°-59.6° 2Θ, an eighth peak from about 62.8°-64.5° 2Θ, a ninth peak from about 65°-67.4° 2Θ, and a tenth peak from about 68.1°-69.2° 2Θ. In an alternate embodiment, the desodiated nickelate material has an XRD pattern having at least 1, 2, 3, 4, 5, 6, 7, 8, 9, or 10 of these ten peaks or sets of peaks.

In an embodiment, said pre-aged, desodiated nickelate material has been prepared by pre-aging a desodiated nickelate precursor using a pre-aging solution comprising a hydroxide.

In an embodiment, the hydroxide is selected from the group consisting of alkali and alkaline earth metal hydroxides. In an embodiment, the hydroxide is selected from the group consisting of LiOH, NaOH, KOH, and Ca(OH)₂. In an embodiment, the hydroxide is LiOH or NaOH. In an embodiment, the hydroxide is LiOH. In an embodiment, the hydroxide is NaOH.

In an embodiment, the hydroxide concentration of said pre-aging solution is about 0.005 M to about 1 M. In an embodiment, the hydroxide concentration is at least, at most, or about 0.005, 0.01, 0.02, 0.05, 0.1, 0.2, 0.3, 0.4, 0.5, 0.6, 0.7, 0.8, 0.9, or 1.0 M, or within a range defined by any two of these values.

In an embodiment, the pre-aging solution to desodiated nickelate precursor ratio was from about 1 mL/g to about 100 mL/g. In an embodiment, the ratio was at least, at most, or about 1, 2, 5, 10, 20, 30, 40, 50, 60, 70, 80, 90, or 100 mL/g, or within a range defined by any two of these values.

In an embodiment, said desodiated nickelate precursor was pre-aged for about 1-60 minutes. In an embodiment, the desodiated nickelate precursor was pre-aged for about 1-30 minutes, or about 1-20 minutes. In an embodiment, the desodiated nickelate precursor was pre-aged for at least, at most, or about 1, 2, 5, 10, 15, 20, 25, 30, 35, 40, 45, 50, 55, or 60 minutes, or within a range defined by any two of these values.

In an embodiment, said pre-aged, desodiated nickelate material was pre-aged at a temperature between about 0° C. to about 40° C. In an embodiment, said pre-aged, desodiated nickelate material was pre-aged at a temperature of at least, at most, or about 0, 5, 10, 15, 20, 25, 30, 35, or 40° C., or within a range defined by any two of these values.

An embodiment is a method of producing a pre-aged, desodiated nickelate material, said method comprising:
iii) contacting a sodium nickelate with an acid solution, so as to produce an acid-leached, desodiated nickelate; and
iv) contacting said acid-leached, desodiated nickelate with a pre-aging solution comprising a hydroxide, so as to produce the pre-aged, desodiated nickelate material.

In an embodiment, said acid-leached, desodiated nickelate has the formula NaₓNiO₂, wherein 0≤x≤0.2. In an embodiment, x is at least, at most, or about 0, 0.025, 0.05, 0.075, 0.1, 0.125, 0.15, 0.175, or 0.2, or within a range defined by any two of these values.

In an embodiment, said acid solution comprises an acid selected from the group consisting of sulfuric acid, hydrochloric acid, nitric acid, hydrobromic acid, hydroiodic acid, and perchloric acid. In an embodiment, said acid is sulfuric acid.

In an embodiment, said acid is present at a concentration of about 0.01 M to about 10 M. In an embodiment, said acid is present at a concentration of at least, at most, or about 1, 1.5, 2, 2.5, 3, 3.5, 4, 4.5, or 10 M, or within a range defined by any two of these values.

In an embodiment, step i) is performed for a period of time ranging from about 1 minute to about 60 hours. In an embodiment, the period of time is at least, at most, or about 1, 2, 5, 10, 20, 30, 40, or 50 minutes, or 1, 2, 3, 4, 5, 6, 7, 8, 9, or 60 hours, or within a range defined by any two of these values.

In an embodiment, step i) is performed at a temperature from about −5 to about 20° C. In an embodiment, the temperature is at least, at most, or about −5, 0, 5, 10, 15, or 20° C., or within a range defined by any two of these values.

In an embodiment, step i) is performed using about 10 mL to about 200 mL of acid solution per gram of sodium nickelate. In an embodiment, step i) is performed using at least, at most, or about 10, 20, 30, 40, 50, 60, 70, 80, 90, 100, 110, 120, 130, 140, 150, 160, 170, 180, 190, or 200 mL of acid solution per gram of sodium nickelate, or within a range defined by any two of these values.

In an embodiment, the hydroxide is selected from the group consisting of alkali and alkaline earth metal hydroxides. In an embodiment, the hydroxide is selected from the group consisting of LiOH, NaOH, KOH, and Ca(OH)₂. In an embodiment, said pre-aging solution comprises a hydroxide selected from the group consisting of LiOH, NaOH, Ca(OH)₂.

In an embodiment, said hydroxide is present at a concentration of about 0.005 M to about 1 M. In an embodiment, the hydroxide concentration is at least, at most, or about 0.005, 0.01, 0.02, 0.05, 0.1, 0.2, 0.3, 0.4, 0.5, 0.6, 0.7, 0.8, 0.9, or 1.0 M, or within a range defined by any two of these values.

In an embodiment, step ii) is performed for a period of time ranging from about 1-60 minutes. In an embodiment, step ii) is performed for at least, at most, or about 1, 2, 3, 4, 5, 10, 15, 20, 25, 30, 35, 40, 45, 50, 55, or 60 minutes, or within a range defined by any two of these values.

In an embodiment, step ii) is performed at a temperature from about 0 to about 40° C. In an embodiment, step ii) is performed at at least, at most, or about 0, 2, 5, 10, 15, 20, 25, 30, 35, or 40° C., or within a range defined by any two of these values

An embodiment is a pre-aged, desodiated nickelate material made by any method described herein.

An embodiment is an alkaline cathode composition comprising any pre-aged, desodiated nickelate material described herein and electrolytic manganese dioxide (EMD).

In an embodiment, the ratio of nickel to manganese is from 99:1 to 1:99 by weight. In an embodiment, the ratio of nickel to manganese is at least, at most, or about 99:1, 95:5, 90:10, 80:20, 70:30, 60:40, 50:50, 40:60, 30:70, 20:80, 10:90, 5:95, or 1:99, or within a range defined by any two of these values.

An embodiment is an alkaline cathode composition comprising any pre-aged, desodiated nickelate material described herein, electrolytic manganese dioxide, graphite, and a binder.

In an embodiment, the pre-aged, desodiated nickelate material is present in an amount of about 8.8-45.1 wt. %, the electrolytic manganese dioxide is present in an amount of about 48-84.3 wt. %, the graphite is present in an amount of about 3-8 wt. %, and the binder is present in an amount of about 0.1-1.0 wt. %, relative to the total weight of the nickelate, EMD, graphite, and binder. In an embodiment, the pre-aged, desodiated nickelate material is present in an amount of at least, at most, or about 8.8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, or 45.1 wt. %, or within a range defined by any two of these values. In an embodiment, the electrolytic manganese dioxide is present in an amount of at least, at most, or about 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 84.3 wt. %, or within a range defined by any two of these values. In an embodiment, the graphite is present in an amount of at least, at most, or about 3, 4, 5, 6, 7, or 8 wt. %, or within a range defined by any two of these values. In an embodiment, the binder is present in an amount of at least, at most, or about 0.1, 0.2, 0.3, 0.4, 0.5, 0.6, 0.7, 0.8, 0.9, or 1.0 wt. %, or within a range defined by any two of these values.

In an embodiment, the pre-aged, desodiated nickelate material and EMD, together, are present in an amount of about 92-97 wt. %, the graphite is present in an amount of about 3-8 wt. %, and the binder is present in an amount of about 0.1-1.0 wt. %. In an embodiment, the pre-aged, desodiated nickelate material and EMD, together, are present in an amount of at least, at most, or about 92, 93, 94, 95, 96, or 97 wt. %, or within a range defined by any two of these values. In an embodiment, the graphite is present in an amount of at least, at most, or about 3, 4, 5, 6, 7, or 8 wt. %, or within a range defined by any two of these values. In an embodiment, the binder is present in an amount of at least, at most, or binder is present in an amount of at least, at most, or about 0.1, 0.2, 0.3, 0.4, 0.5, 0.6, 0.7, 0.8, 0.9, or 1.0 wt. %, or within a range defined by any two of these values.

An embodiment is a desodiated nickelate material comprising the following phases:
i) 15-50 wt % NiO₂;
ii) 20-60 wt % β-NiOOH;
iii) 0-25 wt % H_{0.61}NiO₂(H₂O)_{0.91}; and
iv) 0-25 wt % Na_{0.33}NiO₂(H₂O)_{0.54}.

In an embodiment, the NiO₂ is present in an amount of at least, at most, or about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt. %, or within a range defined by any two of these values. In an embodiment, the β-NiOOH is present in an amount of at least, at most, or about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt. %, or within a range defined by any two of these values. In an embodiment, the H_{0.61}NiO₂(H₂O)_{0.91} is present in an amount of at least, at most, or about 1, 2, 3, 4, 5, 6, 7, 8, 9, 10, 11, 12, 13, 14, 15, 16, 17, 18, 19, 20, 21, 22, 23, 24, or 25 wt. %, or within a range defined by any two of these values. In an embodiment, H_{0.61}NiO₂(H₂O)_{0.91} is not present. In an embodiment, the Na_{0.33}NiO₂(H₂O)_{0.54} is present in an amount of at least, at most, or about 1, 2, 3, 4, 5, 6, 7, 8, 9, 10, 11, 12, 13, 14, 15, 16, 17, 18, 19, 20, 21, 22, 23, 24, or 25 wt. %, or within a range defined by any two of these values. In an embodiment, Na_{0.33}NiO₂(H₂O)_{0.54} is not present.

An embodiment is a desodiated nickelate material having the formula NaₓNiO₂(H₂O)_{z}, where x=0.01-0.05 and z=0.2-1.1. In an embodiment, x is at least, at most, or about 0.01, 0.02, 0.03, 0.04, or 0.05, or within a range defined by any two of these values. In an embodiment, z is at least, at most, or about 0.2, 0.3, 0.4, 0.5, 0.6, 0.7, 0.8, 0.9, 1.0, or 1.1, or within a range defined by any two of these values.

An embodiment is a nickelate material comprising the following phases:
i) 4-62 wt % Na_{0.33}NiO₂(H₂O)_{0.54};
ii) 30-80 wt % (Li_{0.39}Ni_{0.01})(NiO₂) and/or (Li_{0.49}Ni_{0.01})(NiO₂) and/or (Li_{0.45}Ni_{0.05})(NiO₂); and
iii) 0-50 wt % β-NiOOH.

In an embodiment, the Na_{0.33}NiO₂(H₂O)_{0.54} is present in an amount of at least, at most, or about 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, or 62 wt. %, or within a range defined by any two of these values. In an embodiment, the (Li_{0.39}Ni_{0.01})(NiO₂) and/or (Li_{0.49}Ni_{0.01})(NiO₂) and/or (Li_{0.45}Ni_{0.05})(NiO₂) is present in an amount of at least, at most, or about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt. %, or within a range defined by any two of these values. In an embodiment, the β-NiOOH is present in an amount of at least, at most, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt. %, or within a range defined by any two of these values. In an embodiment, β-NiOOH is not present.

An embodiment is a nickelate material comprising the following phases:
i) 80-85 wt % Na_{0.33}NiO₂(H₂O)_{0.54}; and
ii) 15-20 wt % β-NiOOH.

In an embodiment, the Na_{0.33}NiO₂(H₂O)_{0.54} is present in an amount of at least, at most, or about 80, 81, 82, 83, 84, or 85 wt. %, or within a range defined by any two of these values. In an embodiment, the β-NiOOH is present in an amount of at least, at most, or about 15, 16, 17, 18, 19, or 20 wt. %, or within a range defined by any two of these values.

An embodiment is a nickelate material having the formula NaₓLi_{y}NiO₂(H₂O)_{z}, where x=0.01-0.05, y=0.15-0.45 and z=0.1-0.8. In an embodiment, x is at least, at most, or about 0.01, 0.02, 0.03, 0.04, or 0.05, or within a range defined by any two of these values. In an embodiment, y is at least, at most, or about 0.15, 0.20, 0.25, 0.30, 0.35, 0.40, or 0.45, or within a range defined by any two of these values. In an embodiment, z is at least, at most, or about 0.1, 0.2, 0.3, 0.4, 0.5, 0.6, 0.7, or 0.8, or within a range defined by any two of these values.

An embodiment is a nickelate material which exhibits three discharge plateaus vs. Zn/ZnO reference electrode during discharge to 1.0 V voltage at 10 mA/g discharge rate.

In an embodiment, said nickelate material exhibits a discharge plateau at about 1.85-1.80 V during discharge at 10 mA/g discharge rate.

In an embodiment, said nickelate material exhibits a discharge curve vs. Zn/ZnO at 10 mA/g discharge rate, wherein the discharge curve depicts voltage vs. specific capacity; wherein the specific capacity is separated into a first region, from OCV to 1.63 V; a second region, from 1.63 V to 1.45 V; and a third region, from 1.45 V to 1.00 V; wherein the capacity contribution of a given region is the difference between the capacity at the end of that region and the beginning of that region; and
i) the ratio of the capacity contribution of the second region to the capacity contribution of the first region is less than 10; or
ii) the capacity contribution of the first region is at least 7.0% relative to the total capacity contribution of the first, second, and third regions.

In an embodiment, the ratio of the capacity contribution of the second region to the capacity contribution of the first region is less than 9, 8, 7, 6, 5, 4, 3, 2, or 1. In an embodiment, the capacity contribution of the first region is at least 7.0, 8.0, 9.0, 10.0, 11.0, 12.0, 13.0, 14.0, 15.0, 16.0, 17.0, 18.0, 19.0, or 20.0%, relative to the total capacity contribution of the first, second, and third regions.

An embodiment is a composition comprising particles of a nickelate material, wherein said particles comprise:
i) an interior core, comprising nickelate which has not been pre-aged with a hydroxide; and
ii) an exterior layer, comprising nickelate which has been pre-aged with a hydroxide.

The nickelate which has been pre-aged may be any of the pre-aged, desodiated nickelates described herein. In an embodiment, the interior core comprises a desodiated nickelate as described herein.

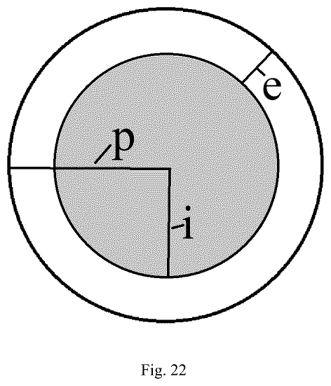

In an embodiment, the exterior layer has a thickness which comprises from 0.1 to 99% of the particle's radius. In an embodiment, the interior core has a radius which comprises from 1% to 99.9% of the particle's radius. This is illustrated in FIG. 22, in which the interior core is shaded; the radius of the particle is labeled as “p”, the radius of the interior core is labeled as “i,” and the thickness of the exterior layer is labeled as “e”. The particle radius can be defined as the sum of the radius interior core and the thickness of the exterior layer (p=i+e).

An embodiment is an alkaline electrochemical cell comprising any nickelate material or composition described herein.

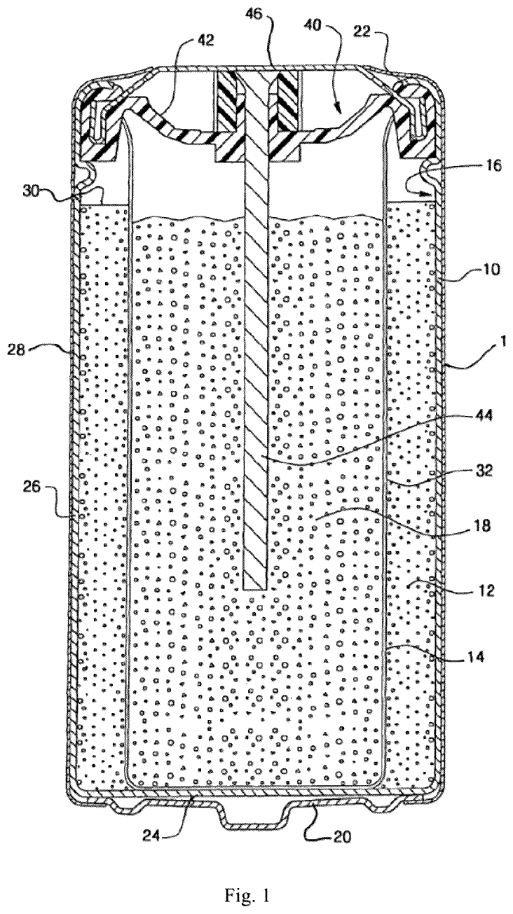

The embodiments will be better understood by reference to FIG. 1 which shows a cylindrical cell 1 in elevational cross-section, with the cell having a nail-type or bobbin-type construction and dimensions comparable to a conventional LR6 (AA) size alkaline cell, which is particularly well-suited to the embodiments. However, it is to be understood that cells according to the embodiments can have other sizes and shapes, such as a prismatic or button-type shape; and other electrode configurations, as known in the art. The materials and designs for the components of the electrochemical cell illustrated in FIG. 1 are for the purposes of illustration, and other materials and designs may be substituted. Moreover, in certain embodiments, the cathode and anode materials may be coated onto a surface of a separator and/or current collector and rolled to form a “jelly roll” configuration.

In FIG. 1, an electrochemical cell 1 is shown, including a container or can 10 having a closed bottom end 24, a top end 22 and sidewall 26 there between. The closed bottom end 24 includes a terminal cover 20 including a protrusion. The can 10 has an inner wall 16. In the embodiment, a positive terminal cover 20 is welded or otherwise attached to the bottom end 24. In one embodiment, the terminal cover 20 can be formed with plated steel for example with a protruding nub at its center region. Container 10 can be formed of a metal, such as steel, preferably plated on its interior with nickel, cobalt and/or other metals or alloys, or other materials, possessing sufficient structural properties that are compatible with the various inputs in an electrochemical cell. A label 28 can be formed about the exterior surface of container 10 and can be formed over the peripheral edges of the positive terminal cover 20 and negative terminal cover 46, so long as the negative terminal cover 46 is electrically insulated from container 10 and positive terminal 20.

Disposed within the container 10 are a first electrode 18 and second electrode 12 with a separator 14 therebetween. First electrode 18 is disposed within the space defined by separator 14 and closure assembly 40 secured to open end 22 of container 10. Closed end 24, sidewall 26, and closure assembly 40 define a cavity in which the electrodes of the cell are housed.

Closure assembly 40 comprises a closure member 42 such as a gasket, a current collector 44 and conductive terminal 46 in electrical contact with current collector 44. Closure member 42 preferably contains a pressure relief vent that will allow the closure member to rupture if the cell's internal pressure becomes excessive. Closure member 42 can be formed from a polymeric or elastomer material, for example Nylon-6,6, an injection-moldable polymeric blend, such as polypropylene matrix combined with poly(phenylene oxide) or polystyrene, or another material, such as a metal, provided that the current collector 44 and conductive terminal 46 are electrically insulated from container 10 which serves as the current collector for the second electrode 12. In the embodiment illustrated, current collector 44 is an elongated nail or bobbin-shaped component. Current collector 44 is made of metal or metal alloys, such as copper or brass, conductively plated metallic or plastic collectors or the like. Other suitable materials can be utilized. Current collector 44 is inserted through a preferably centrally located hole in closure member 42.

First electrode 18 is preferably a negative electrode or anode. The negative electrode includes a mixture of one or more active materials, an electrically conductive material, solid zinc oxide, and a surfactant. The negative electrode can optionally include other additives, for example a binder or a gelling agent, and the like.

Zinc is an example main active material for the negative electrode of the embodiments. Mercury and magnesium may also be used. Preferably, the volume of active material utilized in the negative electrode is sufficient to maintain a desired particle-to-particle contact and a desired anode to cathode (A:C) ratio.

Particle-to-particle contact should be maintained during the useful life of the battery. If the volume of active material in the negative electrode is too low, the cell's voltage may suddenly drop to an unacceptably low value when the cell is powering a device. The voltage drop is believed to be caused by a loss of continuity in the conductive matrix of the negative electrode. The conductive matrix can be formed from undischarged active material particles, conductive electrochemically formed oxides, or a combination thereof. A voltage drop can occur after oxide has started to form, but before a sufficient network is built to bridge between all active material particles present.

The aqueous alkaline electrolyte may comprise an alkaline metal hydroxide such as potassium hydroxide (KOH), sodium hydroxide (NaOH), or the like, or mixtures thereof. Potassium hydroxide is preferred. The alkaline electrolyte used to form the gelled electrolyte of the negative electrode contains the alkaline metal hydroxide in an amount from about 26 to about 36 weight percent, for example from about 26 to about 32 weight percent, and specifically from about 26 to about 30 weight percent based on the total weight of the alkaline electrolyte. Interaction takes place between the negative electrode alkaline metal hydroxide and the added solid zinc oxide, and it has been found that lower alkaline metal hydroxide improves DSC service. Electrolytes which are less alkaline are preferred but can lead to rapid electrolyte separation of the anode. Increase of alkaline metal hydroxide concentration creates a more stable anode but can reduce DSC service.

A gelling agent is preferably utilized in the negative electrode as is well known in the art, such as a crosslinked polyacrylic acid, such as Carbopol® 940, which is available from Noveon, Inc. of Cleveland, Ohio, USA. Carboxymethylcellulose, polyacrylamide and sodium polyacrylate are examples of other gelling agents that are suitable for use in an alkaline electrolyte solution. Gelling agents are desirable in order to maintain a substantially uniform dispersion of zinc and solid zinc oxide particles in the negative electrode. The amount of gelling agent present is chosen so that lower rates of electrolyte separation are obtained and anode viscosity in yield stress are not too great which can lead to problems with anode dispensing.

Other components which may be optionally present within the negative electrode include, but are not limited to, gassing inhibitors, organic or inorganic anticorrosive agents, plating agents, binders or other surfactants. Examples of gassing inhibitors or anticorrosive agents can include indium salts, such as indium hydroxide, perfluoroalkyl ammonium salts, alkali metal sulfides, etc. In one embodiment, dissolved zinc oxide is present preferably via dissolution in the electrolyte, in order to improve plating on the bobbin or nail current collector and to lower negative electrode shelf gassing. The dissolved zinc oxide added is separate and distinct from the solid zinc oxide present in the anode composition. Levels of dissolved zinc oxide in an amount of about 1 weight percent based on the total weight of the negative electrode electrolyte are preferred in one embodiment. The soluble or dissolved zinc oxide generally has a BET surface area of about 4 m²/g or less measured utilizing a Tristar 3000 BET specific surface area analyzer from Micrometrics having a multi-point calibration after the zinc oxide has been degassed for one hour at 150° C.; and a particle size D50 (median diameter) of about 1 micron, measured using a CILAS particle size analyzer as indicated above. In a further embodiment, sodium silicate in an amount of about 0.3 weight percent based on the total weight of the negative electrode electrolyte is preferred in the negative electrode in order to substantially prevent cell shorting through the separator during cell discharge.

The negative electrode can be formed in a number of different ways as known in the art. For example, the negative electrode components can be dry blended and added to the cell, with alkaline electrolyte being added separately or, as in a preferred embodiment, a pre-gelled negative electrode process is utilized.

Second electrode 12, also referred to herein as the positive electrode or cathode, has a nickelate compound (or “nickelate cathode material”) as its electrochemically active material. The active material is present in an amount generally from about 80 to about 98 weight percent and preferably from about 81 to 97 weight percent based on the total weight of the positive electrode, i.e., nickelate cathode material, binder, conductive material, positive electrode electrolyte, and additives, if present.

The active cathode material may be a blend of a nickelate cathode material and other active materials such as electrolytic manganese dioxide (EMD), chemical manganese dioxide (CMD), copper oxide, and others. The weight percentage of the nickel-containing compound could be in the range of 5% to 100% of the total active cathode material. The positive electrode is formed by combining and mixing desired components of the electrode followed by dispensing a quantity of the mixture into the open end of the container and then using a ram to mold the mixture into a solid tubular configuration that defines a cavity within the container in which the separator 14 and first electrode 18 are later disposed (known as impact molding). Second electrode 12 has a ledge 30 and an interior surface 32 as illustrated in FIG. 1. Alternatively, the positive electrode may be formed by preforming a plurality of rings from the mixture comprising the nickelate cathode material, and then inserting the rings into the container to form the tubular-shaped second electrode (known as ring molding). The cell shown in FIG. 1 would typically include 3 or 4 rings.

The active material may be in the form of particles having any size suitable for use in an electrode mixture. In an embodiment, the active material is in the form of particles having an average size of approximately 1-20 microns, or 1-10 microns, or 1-5 microns, or 7-10 microns. In an embodiment, the active material is in the form of particles having a size ranging from 0.1-40 microns.

The cathode also comprises a binder, which may be any binder known in the art. Non-limiting examples of binders include polyvinylidene fluoride (PVDF), polyethylene, copolymers based on polystyrene and ethylene/propylene, such as those available under the Kraton® trade name, sold by Kraton Corporation (Houston, TX), polytetrafluoroethene (PTFE), poly(3,4-ethylenedioxythiophene) (PEDOT) copolymers, polystyrene sulfonate (PSS), and PEDOT:PSS polymer mixtures. The binder may be in the form of particles having any size suitable for use in an electrode mixture.

The cathode also comprises a conductive material, which may be a conductive carbon. The conductive carbon may be graphite, and the graphite may be expanded graphite. The graphite may be in the form of particles having any size suitable for use in an electrode mixture. In an embodiment, the graphite is in the form of particles having an average size ranging from nanoparticle-sized to 65 microns. In an embodiment, the maximum size of the graphite particles is 110 microns.

An example of an additional cathode additive is barium sulfate (BaSO₄), which is commercially available from Bario E. Derivati S.p.A. of Massa, Italy. The barium sulfate is present in an amount generally from about 1 to about 2 weight percent based on the total weight of the positive electrode. Other additives can include, for example, barium acetate, titanium dioxide, binders such as Coathylene® (Axalta Coating Systems, Glen Mills, PA), and calcium stearate.

One of the parameters utilized by cell designers characterizes cell design as the ratio of one electrode's electrochemical capacity to the opposing electrode's electrochemical capacity, such as the anode (A) to cathode (C) ratio, i.e., A:C ratio. For an LR6 type alkaline primary cell that utilizes zinc in the negative electrode or anode and MnO₂ in the positive electrode or cathode, the A:C ratio may be greater than 1.1:1, such as greater than 1.2:1, and specifically 1.3:1 for impact molded positive electrodes. The A:C ratio for ring molded positive electrodes can be about 1.3:1 to about 1.1:1.

Separator 14 is provided in order to separate first electrode 18 from second electrode 12. Separator 14 maintains a physical dielectric separation of the positive electrode's electrochemically active material from the electrochemically active material of the negative electrode and allows for transport of ions between the electrode materials. In addition, the separator acts as a wicking medium for the electrolyte and as a collar that prevents fragmented portions of the negative electrode from contacting the top of the positive electrode. Separator 14 can be a layered ion permeable, non-woven fibrous fabric. A typical separator usually includes two or more layers of paper. Conventional separators are usually formed either by pre-forming the separator material into a cup-shaped basket that is subsequently inserted under the cavity defined by second electrode 12 and closed end 24 and any positive electrode material thereon or forming a basket during cell assembly by inserting two rectangular sheets of separator into the cavity with the material angularly rotated 90° relative to each other. Conventional pre-formed separators are typically made up of a sheet of non-woven fabric rolled into a cylindrical shape that conforms to the inside walls of the second electrode and has a closed bottom end.

All of the references cited above, as well as all references cited herein, are incorporated herein by reference in their entireties.

While embodiments have been illustrated and described in detail above, such illustration and description are to be considered illustrative or exemplary and not restrictive. It will be understood that changes and modifications may be made by those of ordinary skill within the scope and spirit of the following claims. In particular, embodiments include any combination of features from different embodiments described above and below.

The embodiments are additionally described by way of the following illustrative non-limiting examples that provide a better understanding of the embodiments and of its many advantages. The following examples are included to demonstrate preferred embodiments. It should be appreciated by those of skill in the art that the techniques disclosed in the examples which follow represent techniques used in the embodiments to function well in the practice of the embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the embodiments.

### DISCUSSION AND EXAMPLES

### Example 1: NaNiO₂ Synthesis

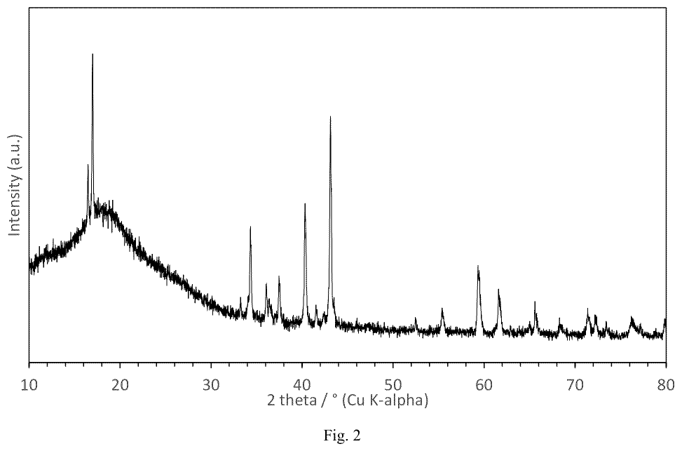

Ni(OH)₂ was calcined at 650° C. in air for 6 hr to convert to NiO. The resultant NiO and Na₂O₂ purchased from Sigma-Aldrich was added into a ball-milling vial to form a mixture with a Na/Ni molar ratio 1.35. The vial was filled with argon in a glove box before the precursors were thoroughly mixed via high energy ball milling for 1 hr. Then the ball-milled mixture was collected into a nickel crucible and covered before being calcined in a furnace at 680° C. in air for 30 hr. The temperature ramp and cool down rate was 5° C./min, and 1° C./min, respectively. The synthesized material was analyzed with an X-ray diffractometer for the powder XRD pattern, and the identified phase is NaNiO₂ as shown in FIG. 2.

### Example 2: Desodiation by Acid Leaching

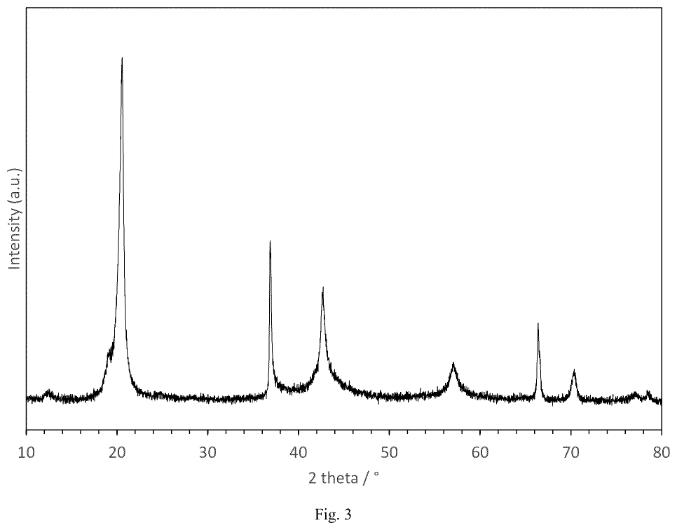

For the desodiation by acid leaching, NaNiO₂ synthesized from Example 1 was added into the bottom of around bottom flask. The flask was immersed in a beaker filled with the water from an ice/water mixture. The starting temperature of the water in the beaker was about 2° C. 4 M H₂SO₄ (10 mL of acid for every gram of powder) was chilled to about −5 to −2° C. in a freezer before the solution was warmed to temperature 0° C. and added to the powder. The first half of the acid was added with a disposable transfer pipette in about 1-3 min. Once half of the acid was added, the rest of the acid were poured into the flask. The beaker/flask setup was then transferred into a fridge controlled at 2° C. and left to be continuously stirred for 4 hr. The final temperature of the water bath is about 5° C. to 6° C. Finally, the contents within the round bottom flask were poured into a filtration setup to filter and wash the powder until the pH of the filtrate matched that of DI water. The powder was dried at 60° C. under a vacuum for 18 hr and thereafter kept in the vacuum for additional 24 hr after turning off the heat. The dried power was identified by XRD mainly as nickel oxide (NiO₂, PDF 04-010-4751) as shown in FIG. 3.

### Example 3: Pristine Powder Aged in 40 wt % KOH/6 wt % ZnO for 24 hr

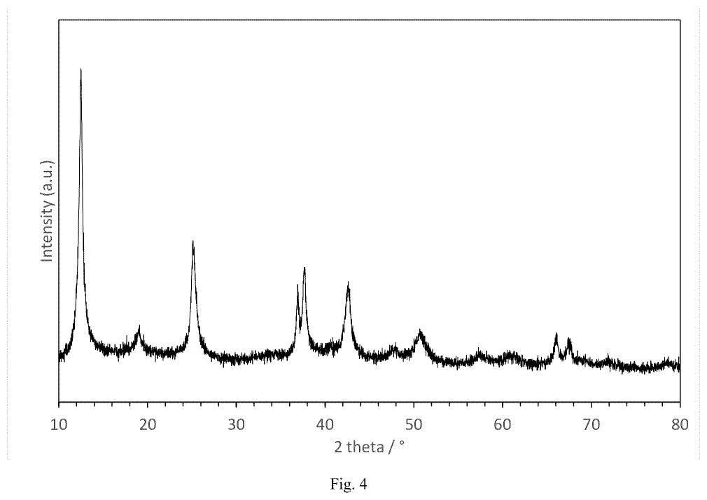

Mixed 0.12 g pristine powder with 0.6 g 40 wt % KOH/6 wt % ZnO in a small beaker, and continuously stirred the solution for 24 hr in room temperature. Poured the contents in the beaker into the filtration setup to filter and wash the powder until the pH of the filtrate matched that of DI water. Dried the powder at 60° C. under a vacuum for 18 hr. The dried material was identified mainly as Na_{0.33}NiO₂(H₂O)_{0.5} (PDF 04-015-9998) as shown in FIG. 4.

### Example 4: LiOH Pre-Aging of Nickel Oxide from Example 2

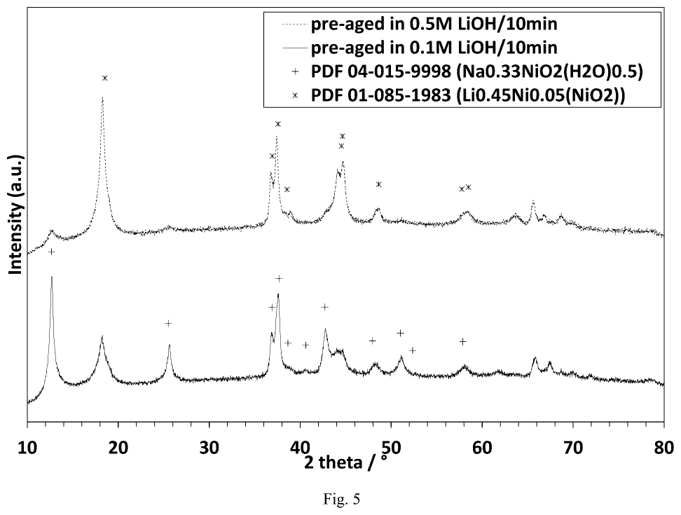

Placed 0.45 g powder from Example 2 into a centrifuge tube, then added 30 mL lithium hydroxide (LiOH) solution into the centrifuge tube to pre-age the material. Shook the tube in a circular motion to disperse the agglomerates at the bottom and then let it settle and rest for 10 min. After the pre-aging was complete, the sample was then washed with DI water by vacuum filtration setup until pH of filtrate matches that of DI water. The powder was then dried at 60° C. for 18 hr under vacuum of −1 bar and extended 24 hr additional drying after turning off the heat. XRD revealed that resultant material comprises a mixture of Na_{0.33}NiO(H₂O)_{0.5} (PDF 04-015-9998) and (Li_{0.45}Ni_{0.05})(NiO₂) (PDF 01-085-1983) as shown in FIG. 5. Two different concentrations of LiOH (0.1 M and 0.5 M) were evaluated, and it was found that the sample pre-aged in the higher concentration of LiOH (0.5 M) shows stronger peaks of (Li_{0.45}Ni_{0.05})(NiO₂) than the sample aged in the low LiOH concentration (0.1 M).

### Example 5: Pre-Aged Powder Aged in 40 wt % KOH/6 wt % ZnO for 24 hr

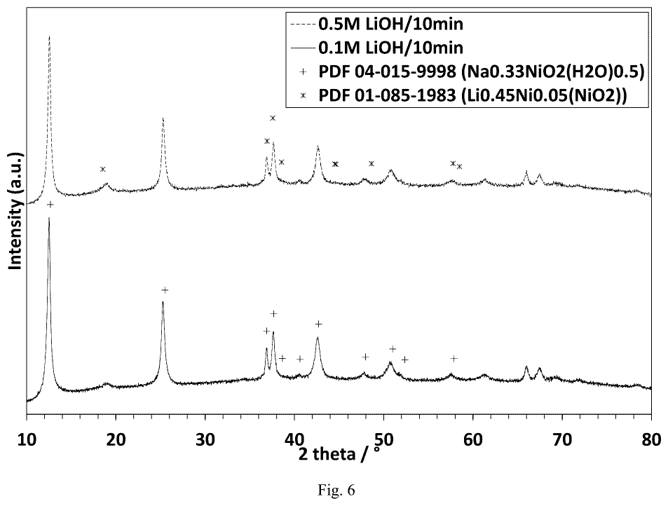

0.5 g of the pre-aged powder from Example 4 was aged in 40 wt % KOH/6 wt % ZnO by following the same condition and procedures as in Example 3. The resultant material comprises the same phases Na_{0.33}NiO(H₂O)_{0.5} (PDF 04-015-9998) and (Li_{0.45}Ni_{0.05})(NiO₂) (PDF 01-085-1983) as the material in Example 4. However, the intensities of Na_{0.33}NiO(H₂O)_{0.5} peaks were significantly increased after aging in KOH solution as shown in FIG. 6.

### Example 6: Preaging Improves the Stability of EMD/Nickelate Mixes

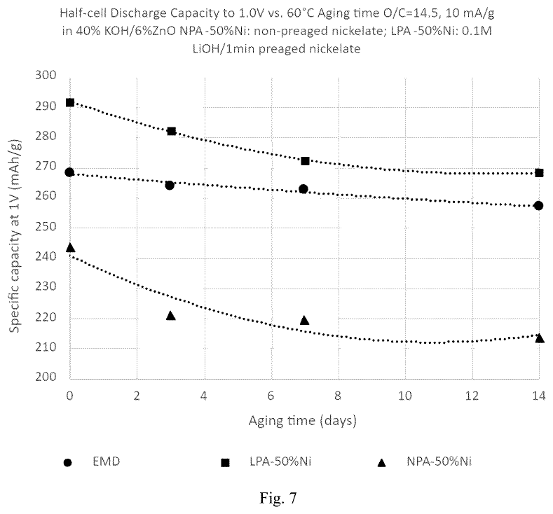

Nickelate/EMD mixtures were discharged in a half-cell testing apparatus after cell aging at 60° C. for up to 14 days to determine the electrochemical discharge capacity retention as the following: EMD (50 wt % Mn relative to total weight of Ni and Mn) was mixed with 6.4 wt % SFG 15 graphite and 0.5 wt % coathylene binder first, then non-preaged nickelate or 0.1 M LiOH 1 min-preaged nickelate (50 wt % Ni relative to total weight of Ni and Mn) was added to form a cathode. The total weight percentage of EMD and nickelate relative to total cathode weight is 93.1 wt %. As a reference, 93.1 wt % EMD relative to total cathode weight (100 wt % Mn relative to total Ni and Mn) with 6.4 wt % SFG 15 graphite and 0.5 wt % coathylene binder were also mixed to form a cathode. 200 mg of the cathode was pressed into a 357-button cell can with a force of 5,000 lbf. The button cell was placed into an acrylic plastic testing fixture filled with 40 wt % KOH with 6 wt % ZnO electrolyte. The acrylic plastic testing fixtures containing nickelate/EMD mixtures cathode were aging in a 60° C. oven for 3, 7 and 14 days, separately. After that, the acrylic plastic testing fixtures were removed from the oven and cooled for 1 hour at room temperature, then the electrolyte was poured out and the acrylic plastic testing fixtures were refilled with 15 g of fresh electrolyte. The acrylic plastic testing fixtures were discharged at 10 mA/g rate with 1 hr rest for every 5 hr discharge to observe voltage recovery. FIG. 7 presents the specific capacity comparison of EMD, non-preaged and LiOH preaged nickelates at 1 V after half-cell aging at 60° C. for up to 14 days. It can be observed that nickelate pre-aged in 0.1 M LiOH for 1 minute (LPA-50% Ni) shows the highest fresh capacity of 292 mAh/g, compared to those of non-preaged nickelate (NPA-50% Ni, 244 mAh/g) and EMD (268 mAh/g). After half-cell aging at 60° C. for 14 days, LPA-50% Ni still maintains a capacity of 268 mAh/g, which is higher than those of NPA-50% Ni (214 mAh/g) and EMD (257 mAh/g), demonstrating the improved stability of EMD/nickelate mixture due to preaging treatment.

### Example 7: Preaging Improves the Stability of Nickelate Powders

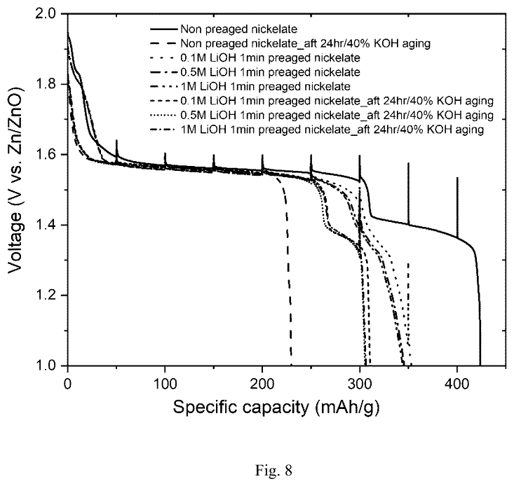

A powder aging test was done for both non-preaged and preaged nickelates. The procedure of powder aging test is as follows. 0.12 g pristine powder with 0.6 g 40 wt % KOH/6 wt % ZnO were first mixed and stirred for 24 hr in a small vial at room temperature. Then, the mixture was washed with DI water by using a filtration setup until pH of washed product is close to 7. The final product is obtained after drying the powder at 60° C. under a vacuum for 18 hr and a further 24 hr after switching off the heating. The pristine powders before and after aging for 24 hr were then discharged in a half-cell testing apparatus to determine the electrochemical discharge capacity as the following: 49 wt % active material was mixed with 49 wt % SFG 15 graphite and 2 wt % coathylene binder to form a cathode mix. 200 mg of the cathode mix was pressed into a 357-button cell can with a force of 5,000 lbf. The button cell was placed into an acrylic plastic testing fixture filled with 40 wt % KOH with 6 wt % ZnO; and discharged at 10 mA/g rate with 1 hr rest for every 5 hr discharge to observe voltage recovery. FIG. 8 shows the discharge curves of non-preaged and LiOH preaged nickelates before and after aging in 40 wt % KOH/6 wt % ZnO for 24 hr. Even though the non-preaged nickelate exhibits the highest initial capacity of 424 mAh/g at 1 V, it only has a capacity of 230 mAh/g after powder aging. In comparison, different concentrated LiOH preaged nickelates show much higher capacities of 305-311 mAh/g (Table 1) after powder aging, demonstrating the improved stability of nickelate from preaging treatment technology.

TABLE 1
Initial OCV and capacity comparison of non-preaged and LiOH pre-
aged nickelates after aged in 40 wt % KOH/6 wt % ZnO for 24 hr.

| | | | | Powder aging 24 hr in 40% | | |
|---|---|---|---|---|---|---|
| | | | | KOH + 6% ZnO | | |
| | Conc | Time | | Initial | Capacity at | Capacity at |
| Lot# | (M) | (min) | OH | OCV (V) | 1.48 V | 1.00 V |
| No pre- | N/A | N/A | N/A | 1.81 | 223 | 230 |
| aging | | | | | | |
| 1 | 0.1 | 1 | Li | 1.83 | 265 | 311 |
| 2 | 0.5 | 1 | Li | 1.82 | 260 | 305 |
| 3 | 1 | 1 | Li | 1.83 | 263 | 306 |

### Example 8: Optimization of EMD/Preaged Nickelate Mix

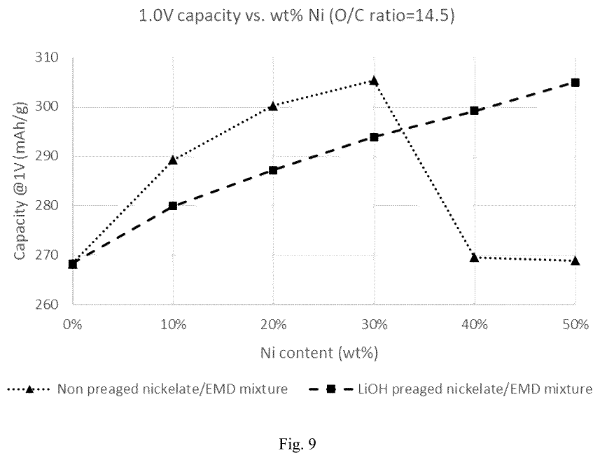

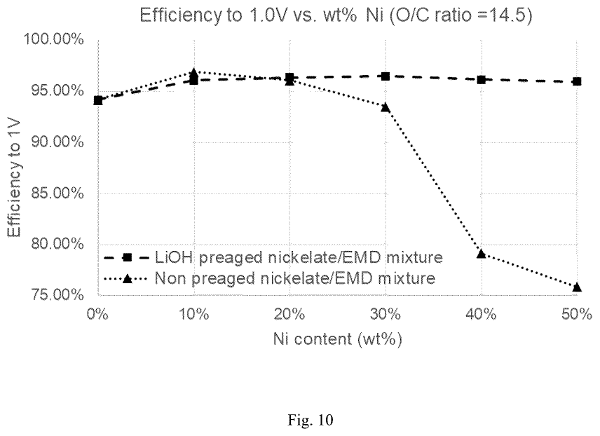

0.1 M LiOH preaged nickelate/EMD mixtures were discharged in a half-cell testing apparatus to determine the electrochemical discharge capacity and efficiency as follows: 0.1 M LiOH preaged nickelate and EMD with a certain ratio (93.1 wt % of total nickelate and EMD relative to total cathode weight) was mixed with 6.4 wt % SFG 15 graphite and 0.5 wt % coathylene binder to form a cathode mix. 200 mg of the cathode mix was pressed into a 357-button cell can with a force of 5,000 lbf. The button cell was placed into an acrylic plastic testing fixture filled with 40 wt % KOH with 6 wt % ZnO; and discharged at 10 mA/g rate with 1 hr rest for every 5 hr discharge to observe voltage recovery. FIGS. 9 and 10 compare the specific capacity and the efficiency of 0.1 M LiOH preaged nickelate/EMD mixture with different wt % relative Ni at 1 V, respectively. It can be observed that the 0.1 M LiOH preaged nickelate/EMD mixture with 50 wt % relative Ni content (meaning 50 wt % Ni, relative to the total amount of nickel and manganese) exhibits the highest capacity at 1 V, compared to non-preaged nickelate/EMD mixtures. Especially compared to non-preaged nickelate/EMD mixtures, the efficiency of 0.1 M LiOH preaged nickelate/EMD mixtures are largely improved (FIG. 10). Overall, 50 wt % relative Ni is the optimal Ni content for 0.1 M LiOH preaged nickelate/EMD mixture, which demonstrates a good capacity (305 mAh/g) and high efficiency (96%) at 1 V.

### Example 9: XRD Fingerprints Before and After LiOH Preaging

Table 2, below, depicts XRD peak positions (2Θ) of desodiated NaNiO₂ (acid-treated, non-preaged, FIG. 3) and LiOH preaged nickelate (acid-treated, pre-aged, FIG. 5) along with XRD peak positions of another nickelate material, described in U.S. Pat. No. 11,560,321B2.

TABLE 2

| | U.S. Pat. No. | | Acid treated NaNiO₂ (Non- | | | LiOH Pre-aged NaₓNiO₂ (LiOH | |
|---|---|---|---|---|---|---|---|
| Peak | 11,560,321B2 | Peak | preaged nickelate) (Ex. 2) | | Peak | preaged nickelate) (Ex. 4) | |
| 2 | 11.8-13.0 | 1 | 11.9-14 | | 1 | 11.9-13.8 | |
| 3 | 18.1-19.7 | 2 | 18-22 | | 2 | 17-19.5 | |
| 1 | 24.5-25.7 | 3 | 36.1-38.6 | | 3 | 24.7-26.5 | |
| 5 | 36.4-38.0 | 4 | 41-44.2 | | 4 | 36.3-39.2 | |
| 4 | 40.0-41.6 | 5 | 55.7-58.9 | NiO₂ | 5 | 41.9-45.7 | |
| 6 | 43.0-43.4 | 6 | 65-67.3 | | 6 | 47.5-49.5 | |
| 10 | 45.3-46.9 | 7 | 69.5-71.3 | NiO₂ | 7 | 50.3-52 | Na_{0.33}NiO₂(H₂O)_{0.54} |
| 11 | 47.4-49.0 | | | | 8 | 57.4-58.7 | Na_{0.33}NiO₂(H₂O)_{0.54} |
| | | | | | | | (Li_{0.45}Ni_{0.05})(NiO₂) |
| 7 | 59.6-60.4 | | | | 9 | 65-68 | |
| 9 | 62.6-63.0 | | | | | | |
| 8 | 65.2-66.8 | | | | | | |

For desodiated, non-preaged NaNiO₂ (FIG. 3), it can be observed that the fifth peak from about 55.7-58.9 2θ and the seventh peak from 69.5-71.3 2θ corresponds to NiO₂ phase, which are different from any peaks in patent U.S. Pat. No. 11,560,321B2. For desodiated, preaged NaNiO₂ (FIG. 5), it can be observed that the seventh peak from about 50.3-52 2θ and the eighth peak from 57.4-58.7 2θ corresponds to Na_{0.33}NiO₂(H₂O)_{0.54} and (Li_{0.45}Ni_{0.05})(NiO₂) phases, which are different from any peaks of the material described in U.S. Pat. No. 11,560,321B2.

Table 3, below, contains the peak positions (2Θ) described in Table 2, along with additional XRD peaks from non-preaged nickelate, and LiOH preaged nickelates from additional synthesis routes.

TABLE 3

| | | | Acid treated | | Non-preaged | | LiOH Preaged | | |
|---|---|---|---|---|---|---|---|---|---|
| | | | NaNiO₂ | | nickelates | | NaₓNiO₂ (LiOH | | LiOH preaged |
| | | | (Non-preaged | | (new synthetic | | preaged | | nickelates |
| | U.S. Pat. No. | | nickelate) | | route, Ex. | | nickelate) | | (new synthetic |
| Peak | 11,560,321 | Peak | (Ex. 2) | Peak | 10 and 11) | Peak | (Ex. 4) | Peak | route, Ex. 12) |
| 2 | 11.8-13.0 | 1 | 11.9-14 | 1 | 11.3-14.6 | 1 | 11.9-13.8 | 1 | 11.1-14.4 |
| 3 | 18.1-19.7 | 2 | 18-22 | 2 | 17.3-22.3 | 2 | 17-19.5 | 2 | 17.2-19.9 |
| 1 | 24.5-25.7 | 3 | 36.1-38.6 | 3 | 23.8-25.9 | 3 | 24.7-26.5 | 3 | 24.1-26.0 |
| 5 | 36.4-38.0 | 4 | 41-44.2 | 4 | 27.2-28.2 | 4 | 36.3-39.2 | 4 | 35.8-39.3 |
| 4 | 40.0-41.6 | 5 | 55.7-58.9 | 5 | 36.2-37.7 | 5 | 41.9-45.7 | 5 | 43.4-45.4 |
| 6 | 43.0-43.4 | 6 | 65-67.3 | 6 | 40-44 | 6 | 47.5-49.5 | 6 | 47.7-49.4 |
| 10 | 45.3-46.9 | 7 | 69.5-71.3 | 7 | 55.7-58.5 | 7 | 50.3-52 | 7 | 56.8-59.6 |
| 11 | 47.4-49.0 | | | 8 | 65.2-67.3 | 8 | 57.4-58.7 | 8 | 62.8-64.5 |
| 7 | 59.6-60.4 | | | 9 | 69.5-71.1 | 9 | 65-68 | 9 | 65-67.4 |
| 9 | 62.6-63.0 | | | | | | | 10 | 68.1-69.2 |
| 8 | 65.2-66.8 | | | | | | | | |

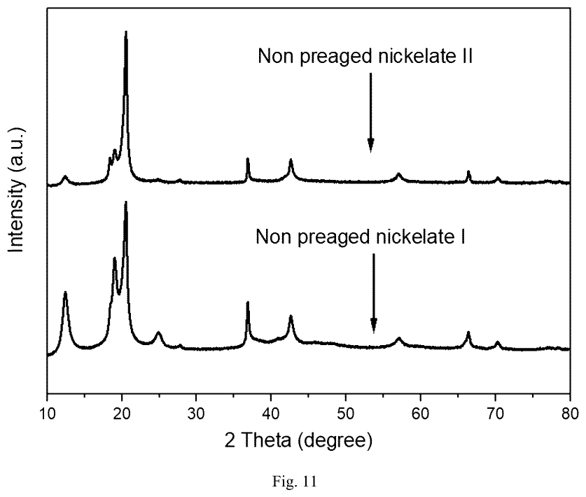

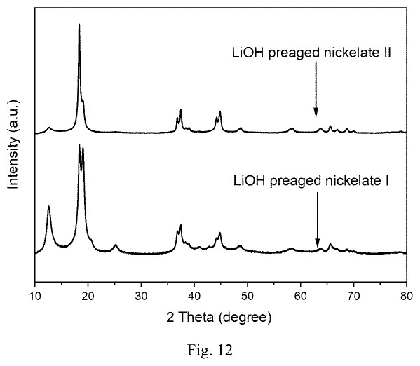

Additional synthesis routes of non-preaged nickelates and LiOH preaged nickelates (described in Examples 10-12) were slightly adjusted for the purpose of scaling up, and show distinct XRD fingerprints, as seen in FIGS. 11 and 12.

Peak Split Phenomenon

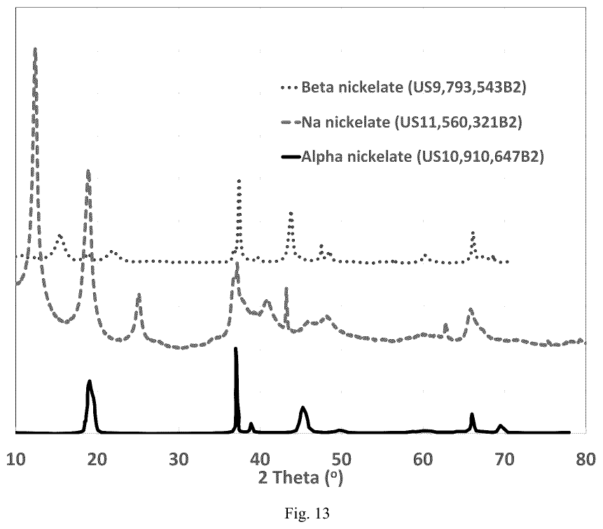

For non-preaged nickelates, there is a peak split of the main XRD peak from about 17.3-22.3 2θ (FIG. 11), which cannot be observed in alpha, beta and the sodium nickelate in U.S. Pat. No. 11,560,321B2 (FIG. 13). It can be subdivided into three peaks with different intensity ratios, corresponding to H_{0.61}NiO₂(H₂O)_{0.91}, 3-NiOOH and NiO₂ phases, separately.

For LiOH preaged nickelates, there are peak splits at second peak from about 17.2-19.9 2θ, fourth peak from about 36.4-37.8 2θ, and fifth peak from about 43.4-45.4 2θ (FIG. 12), which cannot be observed in alpha, beta and X nickelates (FIG. 13). This is due to the presence of multiple phases such as β-NiOOH, Na_{0.33}NiO₂(H₂O)_{0.54} and (Li_{0.39}Ni_{0.01})(NiO₂) components in LiOH preaged nickelates.

Unique XRD Peaks

For non-preaged nickelates, it can be observed that the fourth peak from about 27.2-28.2 2θ, the seventh peak from 55.7-58.5 2θ and the ninth peak from 69.5-71.1 2θ (Table 3), are different from any peaks in U.S. Pat. No. 11,560,321B2.

For LiOH preaged nickelates, it can be observed that the fifth peak from about 43.4-45.4 2θ, the seventh peak from 56.8-59.6 2θ and the tenth peak from 68.1-69.2 2θ (Table 3), are different from any peaks in U.S. Pat. No. 11,560,321B2.

### Example 10: Synthesis of Non-Preaged Nickelate I

Ni(OH)₂ was calcined at 650° C. in air for 6 hr to convert to NiO. 8.963 g resultant NiO and 6.319 g Na₂O₂ purchased from Sigma-Aldrich were added into a ball-milling vial to form a mixture. The ball mill vial was then purged with argon in a glove box before mixing through high energy ball milling for 1 hr. Then the ball-milled mix was collected onto a nickel crucible (55 mL) and covered with a lid before being calcined in a furnace at 680° C. in air for 30 hrs. The temperature ramp and cool down rate was 5° C./min, and 1° C./min, respectively. After taking out the powder from the furnace at 120° C., 13 g of the powder was added into the bottom of a round bottom flask, which was then immersed in a beaker filled with the water from an ice/water mixture. 4 M sulfuric acid (sample mass to volume ratio 1:10 g/mL) at a temperature of 0° C. was then added in the flask and stirred for 4 hr in a fridge (2° C.). Afterwards, the sample was first washed by centrifugation method (1500/2000 rpm, 1-2 mins, 0-4° C.) to remove the acid. Subsequently, the sample was washed by DI water through filtration setup. After drying the washed sample under vacuum for 10 mins, followed by continuous heating at 60° C. for 18 hr, and cooling down for ˜22-24 hr, the final product non-preaged nickelate I was obtained. FIG. 11 represents the XRD pattern of synthesized non-preaged nickelate I.

### Example 11: Synthesis of Non-Preaged Nickelate II

Ni(OH)₂ was calcined at 650° C. in air for 6 hr to convert to NiO. 11.204 g resultant NiO and 7.895 g Na₂O₂ purchased from Sigma-Aldrich were each added into two ball-milling vials to form a mixture. The ball mill vials were then purged with argon in a glove box before mixing through high energy ball milling for 1 hr. Then the ball-milled mix was collected onto a nickel crucible (250 mL) and covered with a lid before being calcined in a furnace at 680° C. in air for 30 hrs. The temperature ramp and cool down rate was 5° C./min, and 1° C./min, respectively. After taking out the powder from the furnace at 130° C., 34 g of the powder was added into the bottom of two round bottom flasks, which was then immersed in a beaker filled with the water from an ice/water mixture, separately. 4 M sulfuric acid (sample mass to volume ratio 1:10 g/mL) at a temperature of 0° C. was then added into each flask and stirred for 4 hr in a fridge (2° C.). Afterwards, the samples were washed using DI water via vacuum filtration using a large ceramic filter cup. After drying the washed sample under vacuum for 10 mins, followed by continuous heating at 60° C. for 18 hr, and cooling down for ˜22-24 hr, the final product non-preaged nickelate II is obtained. FIG. 11 represents the XRD pattern of synthesized non-preaged nickelates II.

### Example 12: Synthesis of LiOH Preaged Nickelates TI

First, 40 mL 0.1 M LiOH solution was added to a centrifuge tube containing 0.6 g non-preaged nickelate I/II powder. After shaking the tube in a circular motion, it was allowed to stand for about 1 minute at room temperature to preage the material. The sample was then washed with DI water using a vacuum filtration setup and dried in a vacuum oven at 60° C. for 18 hr. The final product LiOH preaged nickelate I/II was obtained. FIG. 12 represents the XRD patterns of synthesized LiOH preaged nickelates I/II. LiOH preaged nickelates were also prepared by a similar process, but using 0.5 M LiOH.

### Example 13: Na Nickelate Compositions Before and After LiOH Preaging

Rietveld refinement of XRD patterns has enabled quantification of weight percentages of different compounds constituting the non-preaged and preaged nickelates. Desodiated NaNiO₂ was found to comprise 2 to 4 phases namely, 18 to 50 wt % NiO₂ (PDF: 04-010-4751), 20-60 wt % 3-NiOOH (ICSD: 165961), 0-25 wt % Na_{0.33}NiO₂(H₂O)_{0.54} (ICSD: 159386), and 0 to 22 wt % H_{0.61}NiO₂(H₂O)_{0.91} (ICSD:159387). After preaging in LiOH, pre-aged nickelate was found to comprise 2 to 3 phases, namely 0 to 50 wt % 3-NiOOH (ICSD 165961), 4 to 62 wt % Na_{0.33}NiO₂(H₂O)_{0.54} (ICSD: 159386), and 35 to 80 wt % (Li_{0.39}Ni_{0.01})(NiO₂) (ICSD: 78694) or (Li_{0.49}Ni_{0.01})(NiO₂) (ICSD: 78693) or (Li_{0.45}Ni_{0.05})(NiO₂) (ICSD: 78704). After preaging in NaOH, pre-aged nickelate was found to contain 15-20 wt % 3-NiOOH (ICSD 165961) and 80-85 wt % Na_{0.33}NiO₂(H₂O)_{0.54} (ICSD: 159386).

ICP analysis enabled the determination of chemical formula of as-prepared nickelates to follow the general format of NaₓLi_{y}NiO₂(H₂O)_{z}, where x=0.01-0.05 and z=0.2-1.1 before pre-aging and x=0.01-0.05, y=0.15-0.4, and z=0.1-0.8 after pre-aging in LiOH.

A quantification summary of XRD phase compositions and overall chemical composition of non-preaged and preaged nickelates is shown in Table 4, below:

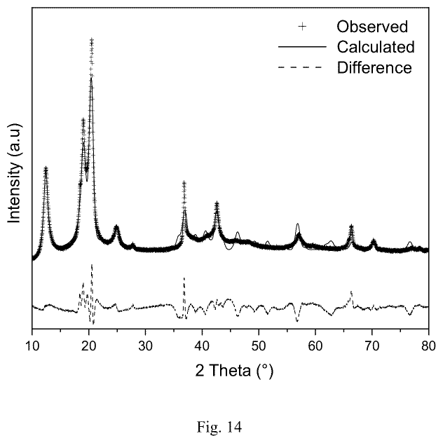

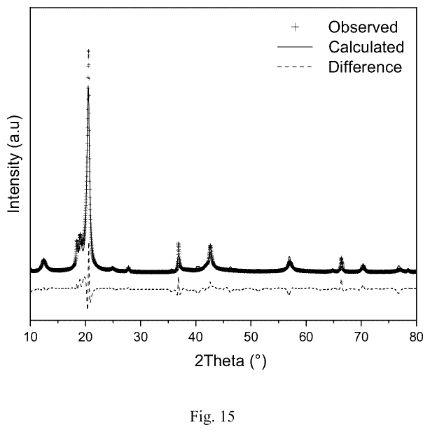

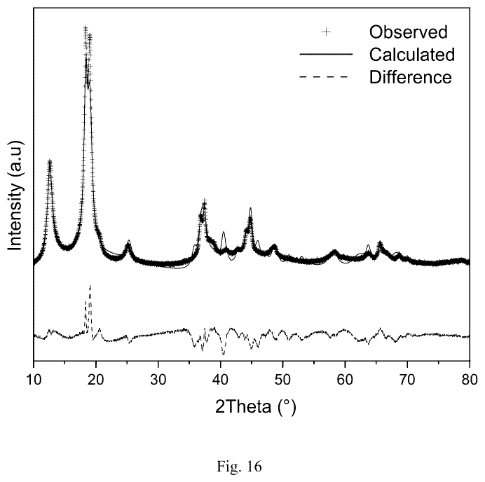

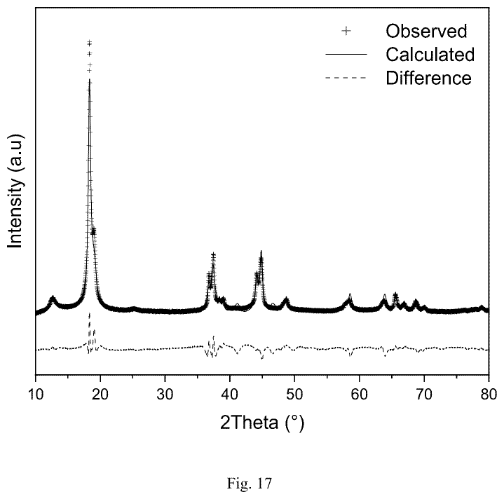

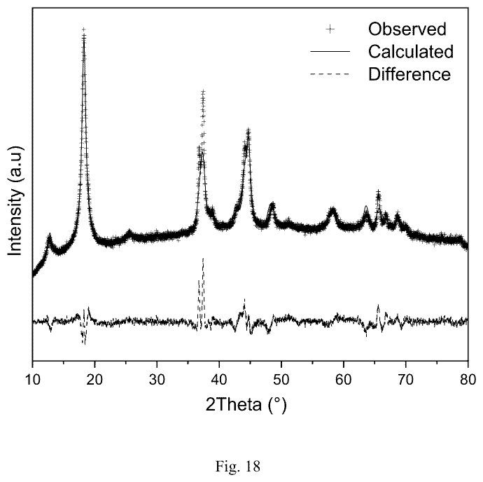

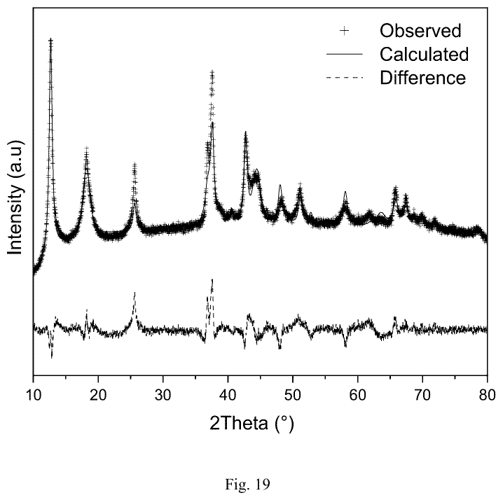

TABLE 4

| | | | | | Predicted chemical | |
|---|---|---|---|---|---|---|
| Sample | | | | | formula calculated from | Chemical formula |
| type | XRD phases detected via Rietveld refinement of XRD patterns (wt %) | | | | XRD pattern refinement | calculated from ICP |
| Non-preaged | NiO₂ | β-NiOOH | Na_{0.33}NiO₂(H₂O)_{0.54} | | H_{0.59}Na_{0.07}NiO₂(H₂O)_{0.12} | |
| nickelate | (18.57%) | (59%) | (22.43%) | | | |
| (I) (FIG. 14) | | | | | | |
| Non-preaged | NiO₂ | β-NiOOH | Na_{0.33}NiO₂(H₂O)_{0.54} | H_{0.61}NiO₂(H₂O)_{0.91} | H_{0.36}Na_{0.03}NiO₂(H₂O)_{0.24} | Na_{0.019}NiO₂(H₂O)_{1.02} |
| nickelate | (47.42%) | (22.52%) | (8.78%) | (21.28%) | | |
| (II) (FIG. 15) | | | | | | |
| Preage in | | β-NiOOH | Na_{0.33}NiO₂(H₂O)_{0.54} | (Li_{0.39}Ni_{0.01})(NiO₂) | H_{0.46}Li_{0.14} Na_{0.07}NiO₂ | |
| LiOH 0.1M | | (45.50%) | (19.80%) | (34.70%) | (H₂O)_{0.11} | |
| 1 min (I) | | | | | | |
| (FIG. 16) | | | | | | |
| Preage in | | β-NiOOH | Na_{0.33}NiO₂(H₂O)_{0.54} | (Li_{0.39}Ni_{0.01})(NiO₂) | H_{0.26} Li_{0.27}Na_{0.01}Ni_{1.01} | Li_{0.28} |
| LiOH 0.1M | | (25.51%) | (4.37%) | (70.11%) | O₂(H₂O)_{0.02} | Na_{0.02}NiO₂(H₂O)_{0.80} |
| 1 min (II) | | | | | | |
| (FIG. 17) | | | | | | |
| Preage in | | | Na_{0.33}NiO₂(H₂O)_{0.54} | (Li_{0.49}Ni_{0.01})(NiO₂) | Li_{0.38} Na_{0.08}Ni_{1.01} | |
| LiOH 0.5M | | | (23.09%) | (76.91)% | O₂(H₂O)_{0.12} | |
| 10 min | | | | | | |
| (FIG. 18) | | | | | | |
| Preage in | | | Na_{0.33}NiO₂(H₂O)_{0.54} | (Li_{0.45}Ni_{0.05})(NiO₂) | Li_{0.17} Na_{0.20}Ni_{1.02} | |
| LiOH 0.1M | | | (61.70%) | (38.30)% | O₂(H₂O)_{0.33} | |
| 10 min | | | | | | |
| (FIG. 19) | | | | | | |
| Preage in | | β-NiOOH (18.01%) | Na_{0.33}NiO₂(H₂O)_{0.54} | | H_{0.18}Na_{0.27}NiO₂(H₂O)_{0.44} | Na_{0.237}NiO₂ |
| NaOH | | | (81.99%) | | | |
| 0.1M 1 min | | | | | | |

Rietveld refinement of XRD pattern of non-preaged nickelate I and non-preaged nickelate II is found in FIGS. 14-15, respectively.

Rietveld refinement of XRD pattern of pre-aged nickelate I (0.1 M LiOH, 1 min) and pre-aged nickelate II (0.1 M LiOH, 1 min) is found in FIGS. 16-17, respectively.

Rietveld refinement of XRD pattern of pre-aged nickelate (0.5 M LiOH, 10 mins) and pre-aged nickelate (0.1 M LiOH, 10 mins), prepared according to Example 4, is found in FIGS. 18-19, respectively.

### Example 14: Discharge Curve Characteristics of NaNiO₂ Derived Nickelates Compared to LiNiO₂ Derived Nickelates Based on 10 mA/g Discharge Rate

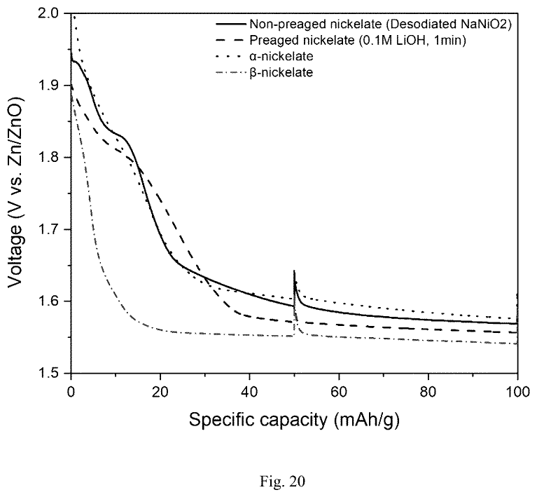

Unlike the discharge curves of α-nickelate and β-nickelate derived from LiNiO₂ the discharge curves of desodiated NaNiO₂ before and after pre-aging in LiOH solution comprise three distinct discharge plateaus during discharge to 1.0V voltage at 10 mA/g discharge rate. Apart from discharge plateaus observed at about 1.60-1.50 V and 1.45-1.35 V, there is an additional unique discharge plateau at about 1.85-1.80 V for desodiated NaNiO₂ before and after LiOH pre-aging, which cannot be observed in α- and β-nickelates. This unique discharge plateau at higher voltage of 1.85-1.80 V could be intrinsic to nickelates derived from acid treatment of sodium nickelate instead of lithium nickelate This is shown in FIG. 20.

### Example 15: Ratio of Capacity Contributions from Different Regions of Discharge Curve

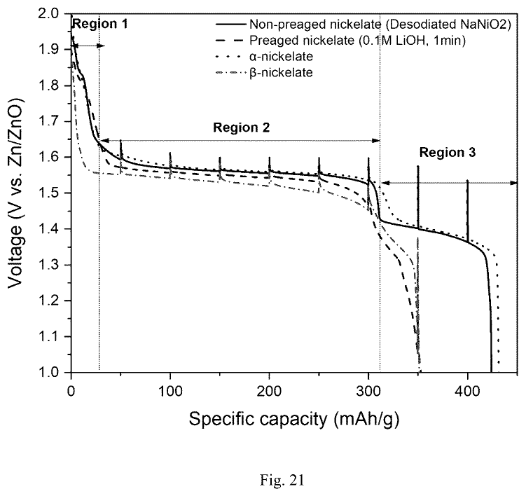

Relatedly, the distribution of specific capacity across various voltage regimes of non-preaged nickelate (desodiated NaNiO₂) and subsequent LiOH preaged nickelates is distinct from that of α-nickelate and β-nickelate as seen from ratios of capacity contribution from 3 regions of discharge curve tabulated in Table 5, below. For ease of comparison of capacity contributions from different voltage regimes, the discharge curve of nickelates has been divided into 3 distinct regions 0.1, 2 and 3, which correspond to OCV to 1.63 V, 1.63 to 1.45 V and 1.45 to 1.00 V respectively. These regions are depicted graphically in FIG. 21.

TABLE 5

| | Capacity | Capacity | Capacity | | | Capacity | Capacity |
|---|---|---|---|---|---|---|---|
| | contribution | contribution | contribution | Discharge | Discharge | contribution | contribution |
| | from OCV to | from 1.63 V | from 1.45 V | capacity at | capacity at | (Region 2)/ | (Region 1)/ |
| | 1.63 V | to 1.45 V | to 1.0 V | 1.45 V cutoff | 1.0 V cutoff | Capacity | Capacity |
| Sample | (mAh/g) | (mAh/g) | (mAh/g) | (mAh/g) | (mAh/g) | contribution | contribution |
| Type | (Region 1) | (Region 2) | (Region 3) | (Region1 + 2) | (Region 1 + 2 + 3) | (Region 1) | (Region 1 + 2 + 3) |
| Non-preaged | 31.3 | 278.9 | 113.8 | 310.2 | 424.1 | 8.9 | 7.4% |
| nickelate | | | | | | | |
| Preage in | 30.3 | 272.2 | 50.5 | 302.4 | 352.9 | 9.0 | 8.6% |
| LiOH 0.1M | | | | | | | |
| 1 min | | | | | | | |
| Preage in | 30.3 | 262.0 | 53.7 | 292.3 | 345.9 | 8.6 | 8.8% |
| LiOH 0.5M | | | | | | | |
| 1 min | | | | | | | |
| Preage in | 36.4 | 269.6 | 53.7 | 305.9 | 359.6 | 7.4 | 10.1% |
| LiOH 0.5M | | | | | | | |
| 10 min | | | | | | | |
| Preage in | 37.9 | 275.0 | 50.6 | 312.8 | 363.4 | 7.3 | 10.4% |
| LiOH 0.1M | | | | | | | |
| 10 min | | | | | | | |
| α-nickelate | 28.5 | 293.8 | 109.2 | 322.3 | 431.6 | 10.3 | 6.6% |
| β-nickelate | 8.0 | 297.6 | 45.5 | 305.6 | 351.1 | 37.1 | 2.3% |

Owing to the capacity contribution from the unique plateau at 1.85-1.8V, the ratio of capacity contribution from region 2 to that of region 1 lies in the distinctly lower range of 7.3-9.0 for non-preaged and LiOH preaged nickelates whereas those of α-nickelate and β-nickelate are above 10. The percentage of capacity contribution from region 1 out of all 3 regions lies from 7.4 to 10.4% for non-preaged and LiOH preaged nickelates whereas those of those of α-nickelate and β-nickelate lie in the range of 2.3 to 6.6%.

1. A desodiated nickelate material, said nickelate material having an X-ray diffraction (XRD) pattern comprising:
(i) first peak from about 11.9°-14° 2Θ, a second set of peaks from about 18°-22° 2Θ, a third peak from about 36.1°-38.60 2Θ, a fourth peak from about 41°-44.2° 2Θ, a fifth peak from about 55.7°-58.9° 2Θ, a sixth peak from about 65°-67.3° 2Θ, and a seventh peak from about 69.5°-71.3° 2Θ; or
(ii) a first peak from about 11.3°-14.60 2Θ, a second set of peaks from about 17.3°-22.3° 2Θ, a third peak from about 23.8°-25.9° 2Θ, a fourth peak from about 27.2°-28.2° 2Θ, a fifth peak from about 36.2°-37.7° 2Θ, a sixth peak from about 40°-44° 2Θ, a seventh peak from about 55.7°-58.5° 2Θ, an eighth peak from about 65.2°-67.3° 2Θ, and a ninth peak from about 69.5°-71.1° 2Θ.

2. (canceled)

3. The desodiated sodium nickelate material of claim 1, wherein said nickelate material has been desodiated via an acid leaching method.

4. A pre-aged, desodiated nickelate material, said pre-aged, desodiated nickelate material having an X-ray diffraction (XRD) pattern comprising:
(i) a first peak from about 11.9°-13.8° 2Θ, a second peak from about 17°-19.5° 2Θ, a third peak from about 24.7°-26.5° 2Θ, a fourth set of peaks from about 36.3°-39.2° 2Θ, a fifth set of peaks from about 41.9°-45.7° 2Θ, a sixth peak from 47.5°-49.5° 2Θ, a seventh peak from about 50.3°-52° 2Θ, an eighth peak from about 57.4°-58.7° 2Θ, and a ninth set of peaks from about 65°-68° 2Θ; or
(ii) a first peak from about 11.1°-14.4° 2Θ, a second set of peaks from about 17.2°-19.9° 2Θ, a third peak from about 24.1°-26.0° 2Θ, a fourth set of peaks from about 35.8°-39.3° 2Θ, a fifth set of peaks from about 43.4°-45.4° 2Θ, a sixth peak from 47.7°-49.4° 2Θ, a seventh peak from about 56.8°-59.6° 2Θ, an eighth peak from about 62.8°-64.5° 2Θ, a ninth peak from about 65°-67.4° 2Θ, and a tenth peak from about 68.1°-69.2° 2Θ.

5. (canceled)

6. The pre-aged, desodiated nickelate material of claim 4, wherein said pre-aged, desodiated nickelate material has been prepared by pre-aging a desodiated nickelate precursor using a pre-aging solution comprising one or more agents selected from the group consisting of hydroxides.

7. The pre-aged, desodiated nickelate material of claim 6, wherein the pre-aging solution comprises a hydroxide selected from the group consisting of LiOH, NaOH, and other alkali and alkaline earth metal hydroxides.

8. (canceled)

9. (canceled)

10. (canceled)

11. (canceled)

12. A method of producing the pre-aged, desodiated nickelate material of claim 4, said method comprising:
i) contacting a sodium nickelate with an acid solution, so as to produce an acid-leached, desodiated nickelate; and
ii) contacting said acid-leached, desodiated nickelate with a pre-aging solution comprising a hydroxide, so as to produce the pre-aged, desodiated nickelate material.

13. The method of claim 12, wherein said acid-leached, desodiated nickelate has the formula NaₓNiO₂, wherein 0≤x≤0.2.

14. The method of claim 12, wherein said acid solution comprises an acid selected from the group consisting of sulfuric acid, hydrochloric acid, nitric acid, hydrobromic acid, hydroiodic acid, and perchloric acid.

15. (canceled)

16. (canceled)

17. (canceled)

18. (canceled)

19. The method of claim 12, wherein step i) is performed using about 10 mL to about 200 mL of acid solution per gram of sodium nickelate.

20. The method of claim 12, wherein said pre-aging solution comprises a hydroxide selected from the group consisting of LiOH, NaOH, Ca(OH)₂, and other alkali and alkaline earth metal hydroxides.

21. (canceled)

22. (canceled)

23. (canceled)

24. (canceled)

25. An alkaline cathode composition comprising the pre-aged, desodiated nickelate material of claim 4 and electrolytic manganese dioxide.

26. (canceled)

27. The alkaline cathode composition of claim 25, further comprising graphite and a binder.

28. The composition of claim 27, wherein the pre-aged, desodiated nickelate material is present in an amount of about 8.8-45.1 wt. %, the electrolytic manganese dioxide is present in an amount of about 48-84.3 wt. %, the graphite is present in an amount of about 3-8 wt. %, and the binder is present in an amount of about 0.1-1.0 wt. %.

29. The composition of claim 27, wherein the pre-aged, desodiated nickelate material and EMD, together, are present in an amount of about 92-97 wt. %, the graphite is present in an amount of about 3-8 wt. %, and the binder is present in an amount of about 0.1-1.0 wt. %.

30. A desodiated nickelate material comprising (A), (B), or (C):
(A)
i) 15-50 wt % NiO₂;
ii) 20-60 wt % β-NiOOH;
iii) 0-25 wt % H_{0.61}NiO₂(H₂O)_{0.91}; and
iv) 0-25 wt % Na_{0.33}NiO₂(H₂O)_{0.54};
(B)
i) 4-62 wt % Na_{0.33}NiO₂(H₂O)_{0.54};
ii) 30-80 wt % (Li_{0.39}Ni_{0.01})(NiO₂) and/or (Li_{0.49}Ni_{0.01})(NiO₂) and/or (Li_{0.45}Ni_{0.05})(NiO₂); and
iii) 0-50 wt % β-NiOOH; or
(C)
i) 80-85 wt % Na_{0.33}NiO₂(H₂O)_{0.54}; and
ii) 15-20 wt % β-NiOOH.

31. A desodiated nickelate material having the formula (i) NaₓNiO₂(H₂O)_{z}, where x=0.01-0.05 and z=0.2-1.1; or (ii) NaₓLi_{y}NiO₂(H₂O)_{z}, where x=0.01-0.05, y=0.15-0.45 and z=0.1-0.8.

32. (canceled)

33. (canceled)

34. (canceled)

35. The nickelate material of claim 4, wherein said nickelate material exhibits three discharge plateaus vs. Zn/ZnO reference electrode during discharge to 1.0V voltage at 10 mA/g discharge rate.

36. The nickelate material of claim 35, wherein said nickelate material exhibits a discharge plateau at about 1.85-1.80 V during discharge at 10 mA/g discharge rate.

37. The nickelate material of claim 35, wherein said nickelate material exhibits a discharge curve vs. Zn/ZnO at 10 mA/g discharge rate, wherein the discharge curve depicts voltage vs. specific capacity; wherein the specific capacity is separated into a first region, from OCV to 1.63 V; a second region, from 1.63 V to 1.45 V; and a third region, from 1.45 V to 1.00 V; wherein the capacity contribution of a given region is the difference between the capacity at the end of that region and the beginning of that region; and
i) the ratio of the capacity contribution of the second region to the capacity contribution of the first region is less than 10; or
ii) the capacity contribution of the first region is at least 7.0% relative to the total capacity contribution of the first, second, and third regions.

38. (canceled)

39. An alkaline electrochemical cell comprising a nickelate material of claim 4.
